(19) United States
(12) Patent Application Publication
(10) Pub. No.: US 2013/0059636 A1
(43) Pub. Date: Mar. 7, 2013

(54) No dealer hand "21" with parlaying propositions

(71) Applicants: J. Richard Hedge, JR., Chandler, AZ (US); Aviva R. Hedge, Chandler, AZ (US)

(72) Inventors: J. Richard Hedge, JR., Chandler, AZ (US); Aviva R. Hedge, Chandler, AZ (US)

(21) Appl. No.: 13/573,452

(22) Filed: Sep. 14, 2012

Related U.S. Application Data
(63) Continuation-in-part of application No. 12/798,864, filed on Apr. 13, 2010, now Pat. No. 8,308,540.

(51) Int. Cl. A63F 1/00; A63F 13/12; A63F 13/00

(52) U.S. Cl. 463/12; 273/292; 463/42

(57) ABSTRACT

The Applicants' provide a process for playing “No Dealer Hand” Twenty-One. Their inventive processes utilize both; Standard decks of Fifty-two (52) cards or any of several types of acceptably configured decks. This process is inclusive to either an encompassing video gaming apparatus or a live action table gaming environment, as accommodated for. In play action, the Dealer's hand is replaced, with the application of Trigger Numbers, ranging anywhere from Twelve (12) up to Twenty (20), and other similarly creative options. Through their designs, the Applicants' present Housemasters with uniquely exploitable degrees of volatility, wherein providing for a malleable core margin variance, meaning a tolerable player vigorish is in play, one that players won't quickly shy away from. In so doing, the Applicants' methods of replacing the Dealer's hand in play, establishes an entirely new frontier for the “Twenty-One” gaming procedure moving forward.

### CROSS-REFERENCE TO RELATED APPLICATIONS

This application is related to application of record; Ser. No. 61/067,429 filed: 28, Feb. 2008,

That is related to this application of record; Ser. No. 12/082,464 filed: 11, Apr. 2008,

That is related to this application of record; Ser. No. 12/798,864 filed: 13, Apr. 2010.

### FIELD OF INVENTION

This invention relates to games of chance as historically identified with wagering in casinos. The Applicants' methods and modifications are inclusive to both a variety of live action table gaming formats as well as electronic display applications for play of all types. Their inventive processes utilize both; Standard decks of Fifty-two (52) cards or any of several differing types of acceptably configured decks, such as; over Fifty-two cards (Jokers included) as well as under Fifty-two cards (aka, Carnival or Spanish decks, etc.) and/or the electronic simulation of all the like, to be specific.

As such, the Applicants' process in allowing Housemasters (i.e. casino management) the ability to apply such a variety of decks is for the direct purpose of; expanding, contracting, and/or otherwise manipulating the core operating margin variances from the usage of such decks, thereby benefitting their game's broader productive utility. More importantly, the present invention utilizes a process formulated upon the “absence of a dealer's hand” throughout the game's course of play regardless of the quantity, and numerical make up of such deck(s) of playing cards being used in play.

Therefore, notwithstanding the various playing card configurations being applied, the absence of the dealer hand is without precedent, and the principle creative action to be focused upon, in contrast to the traditional/classic play of Blackjack in all of its present day forms and permutations. In so teaching, the Applicants' methods proffer a whole new paradigm of opportunity for “21” play within the Applicants' applied industry of casino gaming.

Moreover, a very quick, simplistic method of card play is provided for players looking for a fun, entertaining time wherein a reasonable chance of winning may be had. Presently, the Applicants' know of no previously established methodologies regarding either “live action” table game embodiments of Blackjack/21, including those banked by a House (casino) or electronic “virtual reality” display methods of Blackjack/21 either with or without dealers, which are presently under Patent enforcement or otherwise that might be construed as teaching on or reading upon their concepts and process of play.

### DESCRIPTION OF PRIOR ART

Blackjack is a centuries old game and historically a premier table game in American casinos as well as casinos across the world. No doubt there is good reason for this. America and the world love card games; and they know this game—Blackjack!

Actually, it's a love/hate relationship; just ask anyone who plays the game. People love to play Blackjack especially when the cards give, and of course take, yet no one in any language enjoys getting slaughtered when the dealer stays so “hot” that just simply nothing the player does is right! So, before the disclosure of the Applicants' alternative methodologies, a basic discussion regarding Blackjack's traditional play along with its terminology and historical trends is useful in teaching the Applicants' inventive process as described and illustrated further below.

Simply put, the objective in traditional Blackjack is to beat the dealer's hand. This is accomplished by having a totality of cards that tally (i.e. count) higher than the dealer's cards without going over Twenty-one (21).

Card values in Blackjack are as follows: The Two (2) through Ten (10) Pip-cards are tallied at face value while “Face cards” are valued at Ten (10) and Aces are valued at Eleven (11) or One (1). Likewise, from here forward, the term “Ten card” will define both Ten (10) Pip-cards and/or Jack, Queen & King cards (aka, Court cards).

Similarly, a “Blackjack” hand is always made up of the first two cards dealt. These cards being a Ten card and an Ace. The Blackjack hand is also referred to as a “Natural” or when made with Three (3) or more cards, a “21” and is just as generally unbeatable.

Although, the dirty fact of the game is that a dealer's dealt Blackjack hand will frequently drive a simultaneously dealt player's Blackjack hand into an even money decision or, at the very least, a “Push” stand off outcome for the player's Blackjack hand, meaning the player's hand doesn't win or lose. Likewise, a dealer hand 21 made with Three (3) or more cards will always Push, all other player hand 21's made with Three (3) or more cards. As a practical matter, a player can win with any total under 21 so long as the dealer “Busts” first.

Busting in Blackjack/21 is any final tally higher than Twenty-One (21) for either the player's or the dealer's hand. But unlike the dealer, players will experience the “Double Bust.” The Double Bust occurs when players Bust-out first, followed by the dealer Busting.

It is this constant reality of the Double Bust which players are intractably facing in Blackjack that gives the casino its greatest most frequently exercised “House Percentage Advantage” (aka, “Vig.” or Vigorish) over the players. It is known that the dealer will Bust 28% of the time. However, only the players can experience the Double Bust because the players must act first!

All things being equal, Double Busting provides the House with a constant 5.7% advantage over the players when Double Busting occurs. Therefore, any way you play it within the confines of all “traditional dealer hand methods and rules” for playing Blackjack/21, there remains a powerful House advantage being exacted against all players within the traditional rules of Blackjack, which must be constantly evaded.

This House advantage is the Double Bust effect.

Additional aspects of traditional Blackjack play include the terminology of “Hard,” “Stiff,” “Soft” and “Pat” hands. A Hard hand is one that either does not have an Ace i.e., 9-7/16 or, if it does, it tallies/counts as a One (1), 9-6-A/ 16. Typically, the Hard hand totaling Twelve (12) thru Sixteen (16) is also called a Stiff hand because it can easily Bust when drawing additional cards.

A Soft hand is one that has an Ace being tallied as Eleven (11) amongst the first Two (2) cards being dealt: A-6/17, A-7/18, A-8/19 or A-9/20. Regardless whether the player's hand stands made upon a Hard or Soft 17, 18, 19 or 20, such hands are thought of as “Pat hands.” The next two general strategies of traditional Blackjack play include card “Splitting” and/or “Doubling Down,” both practices of which players are well advised to partake of though tableside restrictions will vary from House to House.

Most often when players engage the practice of card Splitting & Doubling down, the decision is simply weighed against the dealer's “Up-card”. Should the dealer's Up-card be a Bust card; 2, 3, 4, 5 or 6, this often inclines the player to Split their paired cards, such as; 2's, 3's, 4's, - 6's, 7's, 8's, 9's or Aces, when they otherwise may not.

This scenario facilitates a great Splitting opportunity, or better yet as paired Aces reveal, a fantastic multiple Double Down action against a dealer's weak Up-card; although players may draw out as many cards as necessary in a normal card Splitting situation until they either Stand Pat or Busts! Similarly, when Splitting Aces, many casinos allow only One (1) card for each Split Ace and generally the player can only Split Aces once under traditional Nevada rules of play!

In further regards to Doubling Down, again it's a good idea to Double Down whenever the opportunity arises. Although, Doubling Down is sometimes restricted to a player's first Two (2) cards tallying Ten (10) or Eleven (11) only. Moreover, many restrictive rules especially those pertaining to Splitting & Doubling Down are put into place by Housemasters as a means to maintain a desired core operating margin position for their Blackjack games, thereby benefiting their casinos. Therefore, these rules will vary based on many subserviently subjective factors. Additional subservient factors are found within the “Insurance & Surrender” rules as historically applied.

Traditionally, Insurance is offered when the dealer's Up-card is an Ace. For the unwashed, Insurance is generally thought of as a “bad bet,” but does protect the player's wager in the event the dealer has Blackjack with a Ten hole card.

As for the traditional practice of the Surrender rule option (where it is still found), this rule enables the players to withdraw from the hand for half the original contract wager. This action is taken by player(s) when it's felt the dealer's hand is so strong (often repeating Up-card Tens & Aces) and, particularly when the player is holding a “15” or “16” Stiff hand, that keeping half the original contract wager is clearly better than losing all of it.

In America today and throughout the world, Insurance is readily found as part of the Blackjack gaming scene where Surrender rules are not so readily found outside of Asia and Europe. The reasons are simple. Insurance is generally thought of as a bad wager for players to engage in, while Surrendering against continually “strong” dealer hand Up-cards, in a few cases, is a good idea

Of course, the Surrender action as historically deployed assumes the player is not motivated to just simply get up and leave.

The above background rendering of traditional Blackjack/21 rule play pretty much covers all the essential bases of Blackjack play, however certainly not all the “basics” of Blackjack play. As such, the Applicants are referring to the qualities of play employed through the application of the “Basic Strategy” play that are not developed herein. Although, Basic Strategy play is written about in a great many topical books regarding Blackjack.

In following, there are two reasons for not discussing Basic Strategy here. First and foremost, there are no “dealer hand” outcomes that impact upon the Applicants' methodologies for play action. And secondly, any player who is fully immersed in the knowledge of Basic Strategy can easily adjust their play actions accordingly to whatever they see might apply to the Applicants' process for play.

Having said this, there still remains the speculative issue of card counting as well as the dubious issue of “Ante” wager side betting that has so proliferated the world in recent years.

Card counting is the fastest growing somewhat “under the radar” trend of traditional Blackjack, a trend that is a natural consequence of the voluminous numbers of truly well rounded Basic Strategy players at large. Moreover, this encroaching advance against the rather thin House advantage of the traditional Blackjack game; via the art of card counting, as spurred on through strong Basic Strategy knowledge, has become so pervasive in recent years that now every Basic Strategy wanting to be an Advanced Strategy or “Advantage Player” around thinks he can beat Blackjack for their weekend job working as card-counting extraordinaires!

### DESCRIPTION OF THE PRIOR ART

However, as the truly strong Advantage Player will tell you, there is a new and rather deleterious trend, in addition to the pre-requisite ability to accurately count down a deck of cards in less than 30 seconds, working around the Blackjack tables of Las Vegas and around the country which is to pay a natural Blackjack at: 6 to 5 over the traditional Blackjack pay off of 3 to 2.

A single act by Housemasters' (that alone) makes beating the House in Blackjack even by a “Ken Uston,” were he still alive, all but impossible. This “cynical” Blackjack payoff trend adds another 1.40% in the margin to the house's Vig-advantage where players actually play and tolerate this.

Worse yet, this surreptitiously defensive trend is spreading fast and will prove extremely disadvantageous to both the “stout Blackjack players” and the more “profligate too-smart-by-half type weekend players” alike!

Therefore, a general discussion regarding the salient points and trends of card counting is useful in understanding additional motivations of the Applicants' modified methodologies. Effective card counting by way of the professional is steeped in process memorization, including the memorization of fixed strategy tables often referred to as indices of which there are Eighteen (18), plus Four (4) Surrender plays, to be specific.

For example, these indices are memorized strategies counseling within the minds-eye of a basic “Hi-Lo” single level trend count that provides the “edge” that bears the winning advantage so steadily sought after by Blackjack connoisseurs.

The basic Hi-Lo trend count starts at zero upon a new shuffle of a single deck or multi-deck shoe. A shoe is the mechanism from which the dealer advances individual cards up to a multiple of Eight (8) decks. Therefore, unlike Dice or Roulette, Blackjack is made up of a series of “dependent trials” culminating in hands. As such, each “card value” being seen affects the likely outcome of the next card and so on.

So, in assigning numeric count values to cards leaving the shoe, the low cards: 2, 3, 4, 5 or 6 are counted as +1 and all high cards: 10, J, Q, K & Ace are counted as −1. Wherefore, all 7, 8 & 9 cards are ignored being valued at “zero” in the basic Hi-Lo trend count method, while “multi-level” methodologies for example which count some cards as: +2, +3 or even, +4 are significantly more cumbersome for most card counters to learn. However, such skills once acquired are also known to be even more effective especially when a “deep penetration” of the shoe occurs.

Suffice it to say, on the one hand, it's been observed that for the “stout” Blackjack player the main purpose for acquiring the skill and confidence that card counting promises is to know when to “hit” to improve a Stiff hand, increase one's bet spreads or better yet, to pitch the dealer Bust cards from third base when seated at a crowded table.

Although for the largely reckless card counter, what card counting is probably best suited for is avoiding the dreaded Double Bust effect, as well as evaluating both Insurance plays and Surrendering wherever allowed and whenever it's wise.

The fact is these skills alone will save “profligate” weekend players a bundle against a casino full of scorching hot dealers! On the other hand, for today's professional such basic skills would likely be closely augmented by more precise and/or precipitous methodologies like Arnold Snyder's: RED SEVEN or ZEN count methods or the Vancura/Fuchs: KO plus “Ace tracking” methods. Or, say Humble & Cooper's: HI-OPT and HI-OPT II methods, and surely not to be left out Stanford Wong's: HI/LO & “Half-count” methods name just a few, that most Blackjack card counting connoisseurs, Advantage Players, esteem for assuming their mental acuity can remain sharp enough for a long enough session of time to make a difference . . .

In the end, the edge that quality card counting provides is that minds-eye intuitive impetus to “make the play,” and for the very rare breed of gambler that strong pulling back counter-intuitive perspective that can seemingly see ahead with 20/20 hindsight!

However, the collateral effects of card counting are summarily undone when either Basic or Advanced Strategy player mishaps occur . . . Typically impacting somewhere up to 0.75% in the marginal advantage being sought, depending upon their frequency, whereby the player's entire count effort will likely be made in vain.

Now, if this all sounds a bit over the top, maybe it is; and then again, maybe it is not . . . After all, this is a game that now finds a growing number of single deck games paying Naturals at 6 to 5.

Therefore, a significant “redress” for this old favorite could well prove most timely . . . To this end, given the demanding yet fickle nature of Housemasters qualifying a comprehensive redress in the form of a new “top down” rendition for the traditional game of Blackjack will prove tricky. Casino games, especially well established games, evolve ever so slowly due to the rather strident change resistant nature of Housemasters where their table games are concerned.

Just look at Craps' “stats” for the last Twenty (20) plus years, or Hazard & Faro before that. What eventually dissipates as a game ages is the must have public's participation to maintain steady “drop values” (the player's cash buy-in) in significant enough numbers as to support a viable Win % value for the game's continued survival.

It is equally true that Housemasters must simultaneously “exercise & balance” their must have Vig-percentage advantage over their players in wide enough margins while achieving the most viable Win % value possible from the games they run.

In so achieving this result of the most viable Win % value possible, the hourly compellation of hands played is of paramount importance to Housemasters because the hourly decision stream working together with the established Vig-percentage advantage is the cause for all Win % results. As for traditional Blackjack, Forty to Sixty rounds per hour of operation for a full table of Six (6) players will keep a dealer employed. Therefore, a companion gaming process, such as that of the Applicants', promising a minimum “Ten (10) plus percent increase of hands” (decisions) per hour of operation is quite advantageous from the Housemaster's point of view. This assumes the House's Vig-advantage is being exercised & balanced just right for the publics attraction to play!

Another words, to accomplish this, any new gaming solution entering the casino floor must be very quick to learn and be “fat enough in the math” to allow frequent winners, while nurturing the necessary Win % value required for a productive bottom line Hold % for the casino.

Even though all this in itself is a tall order, a game design that meets these tests by the very basis of its methodology is a real plus, a real big plus!

The simple “rule of thumb” for a new game is; if a game's visual introduction can't first pass the “eye clutter” and, say the “beer test” (i.e., the game looks to intimidating), the public most likely won't play, so therefore the game's chances are very slim.

And of course, if a game's core Vig-advantage is too overbearing, the public won't play either so the game's chances are next to nil!

The Gaming industries foundation formula is: Hold %=Win % divided by the Drop. In recent years, a large number of “Side-bet” permutations have hit the Blackjack scene. A long view of Blackjack's numbers and performance would well reveal the significant influence of Basic Strategy training aids as published in so many books and table indices, as well as the impact of computer training aids and video games have had over time; thereby inducing the unending search for additional gaming revenues from this Blackjack workhorse.

Clearly, training aids have been a significant driving resource used by the public at large, perhaps a cause for which Housemasters have been induced into making “margin reducing rule changes along with their abiding results over the years.”

Wherefore such rule changes, for the sake of a “competitive edge,” have starved the very margins of the game. This has resulted in the shaving down of the working House Vig-advantage margins of traditional Blackjack to such an extent as to justify the uptake of so many Side-bet permutations as a means to “re-balance” the then customary Drop, Win & Hold percentages of yesteryear from this perennial Blackjack workhorse. This thinking is also at work as a means to justify this insidious 6 to 5 Blackjack payoff exchange too!

For you see, this Side-bet trend of the last Twenty-five or so years has not only been about satisfying player boredom, as so many prior-art references state. It has also been about defending the traditional boundaries for which the casino's fixed House percentage advantage in the game had historically operated under in the now distancing past.

That is, a perceived House Vig-advantage approaching 6% that in decades past, due to “margin binding rule changes” and “a gross historical miscalculation as to what ‘Blackjack's core margin value’ really was,” has thinned down to about a 2% Vig. for those who have little if any knowledge of Basic Strategy. As applied within advantage play, this accrued margin has been found to be as low as −1.5% to −2% Vigorish impact against the House, favoring the exceptionally well rehearsed card counter or card-counting team.

As such, traditional Blackjack's core operating Vigorish in the final analysis has been steadily pressured, and splintered apart by a progressively wiser, yet still growing player population during this same almost generational period of time. Most Importantly, a great many of whom are at least proficient in Basic Strategy, which means the casino's Vig-advantage edge ranges from about 0.20 of One (1) % to about 0.65 of One (1) %. Of course, this is notwithstanding; “perfected Basic Strategy play” that is a straight-up 50/50 play action, by such players their of, against the House.

Moving forward, it is a good bet that the shear numbers of new inexperienced players alone will likely not stave off continuing pressure upon traditional Blackjack's core margin to somehow produce a better result . . .

Indeed, as the Applicants' know, it takes significant innovation to achieve such ends . . .

A better result that is!

Why who knows, maybe just around the corner, casinos might move even more defensively to paying off Naturals at say: Even Money, and without further recourse for players, thereby further bolstering their margins as a simplistic answer for achieving the greater revenue streams so needed from the games they offer.

From a historical perspective, this is not such a stretch. Clearly, certain prior-art “Blackjack permutation games” that are all about not losing . . . already do pay Blackjack hands at: Even Money. And, in further aggravation to this, a great many casinos have already moved to paying off their traditional “Pitch game Blackjacks” at: 6 to 5.

So, what then is going to be the appeal for playing Blackjack moving forward?

Finally, there is yet one more set of hurdles to consider for a successful venture into the gaming business; the “fat enough in the math” hurdle, as previously alluded too. Moreover, this hurdle is the major intersection of several key issues that are given particular scrutiny and held foremost in the minds of Housemasters as they directly pertain to a new game's working House percentage-advantage edge, or Vig.

The commensurate action to this fat enough in the math hurdle is a hurdle conceptually known as “Time-In-Play,” or TIP. In the casino business, the House's intentions are to part their customers from as much of their cash as possible, but not so fast as to leave them feeling fleeced or ripped-off.

Actually, Housemasters love winners because that is how they earn their money.

“Paying winners” . . . That's how Housemasters “earn on the chum” of play action!

The House always pays off winning wagers a “fraction short of a true odds payoff”

Hence you might say, even though a game's House advantage must necessarily favor the casino, the more sublime yet steady acting the House's Vigorish (as made inviolable to count methods), the better the opportunity for continuing the public's patronage, whereby the game can ultimately become a valuable asset for Housemasters.

Of course, a gambler's TIP is notwithstanding “his own ability” to do something really stupid . . .

### BRIEF SUMMARY OF THE INVENTION

As will become quite clear, the Applicants' are proffering an embodiment for playing “21”.

However unlike classic Blackjack/21, the Applicants' modified process for play action engages a No Dealer Hand approach. Players draw through a flow of cards from either real or simulated deck(s) or shoe(s) of cards until a decision to stand or busting-out upon the next card occurs. Assuming the player is not “Busted” or “Sacked” (loses), the player then stands for a percentage-loss “on the Trigger” or stands to Push or Win, at least even money, or score a short-Win, upon such a winning outcome tally for their hand(s).

In any case, when “Standing Pat” upon a Trigger Number tally or Standing Pat upon a Winning Number tally, players are then exposed to a mathematically formulated and pre-determined scale for loss or payoff Furthermore for the sake of clarity, the terms and depictions being used as illustrated within the exemplary counsels below are to be construed to substantially comprise the following:

First, Primary and/or Secondary level play action “Trigger Numbers,” (a.k.a., TNs). These numbers are any single and/or group/set of numbers spanning from Twelve (12) up to Twenty (20). Another words, any and/or all can be assigned to function as TNs.

Likewise, optional Primary and/or Secondary level play action “Push Numbers,” (a.k.a., PNs) are also assigned play action as any single and/or group/set of numbers spanning from: Twelve (12) up to Twenty (20), as well; while “Winning Numbers” (a.k.a., WNs) and the new type of “short-Winning Numbers” (a.k.a sWNs which typically allows the player to win “half” of their established contract wager), are depicted and assigned to be any single and/or group/set of Primary and/or Secondary level of numbers spanning up to Twenty-One (21).

Additionally affecting the players of this No Dealer Hand methodology is the impact of the new differing types of decks, and/or shoe configurations, being applied during the game's play. As such, the Standardized Fifty-two (52) card decks for play supports a “House-Advantage” edge or HA, of “X” value percentage in the game, while the card configuration of say a Carnival deck configuration having Fifty (50) cards in play would represent a “Y” House Vig-advantage value. Further still, a Spanish configured deck with Forty-eight (48) cards in play offers even yet, a more generous Vig affect of “Z” percentage HA value, as all presently given examples.

A further definition of Carnival and/or Spanish decks being used in play for the Applicants' No Dealer Hand approach defines Carnival decks as having either, their “Red or Black” Ten (10) Pip-cards removed, with the two Joker cards being put in as replacements, whereby having a wide degree of valuation (i.e. wild-card applications) an purpose (i.e. application to the game and/or special marketing tools for the sponsoring casino) for such Jokers, being applied.

Similarly, Housemasters' might simply elect to remove the red or black Ten (10) Pip-cards alone, without Joker replacements. Likewise, the “Spanish-type” decks by definition have all Ten (10) Pip-cards removed from play action, with the uses of Joker cards being strictly a new option.

Furthermore, like traditional Blackjack, players of the No Dealer Hand methodology will also play out; hand Splitting, Doubling Down & Split-Double Down opportunities as Primary & Secondary Base actions for play, just as would be customary within the play action of the traditional game of Blackjack. However, unlike the traditional game, the Applicants' process for play action establishes a simultaneously accessible “parallel play action dynamic” of additional options being more broadly designated as the “Secondary Decisions-class and menu of ‘volatile’ wagers.”

The Secondary Decisions class of wager represents a “fork in the road” of play, so to speak; choices the players have the option to make. Therefore, these very methodologies offer players an “intensive menu of variable risk” for all Secondary play action activity across the Applicants game.

As such, the implementation of the Secondary Decision choices of either the Secondary Base or the Secondary Propositions' Box menu of wagers, now further includes the new and more aggressive Card Drawing Marches or CDM's, Joker's Jackpots and Parlay Blackjack & Power 20 events as all developed below, that represent this fork of avenues for wagering consideration.

As for the Propositions' Box, any hand moving there will play out in a similar manner as the Secondary Base Split-hand, Double Down & Split-Double Down hands do for play action, although for a much greater risk/reward play action payoff result!

Additionally, the Applicants Secondary Decisions' class of wagers bear one more distinctive characteristic in that any player after seeing their first Two (2) cards for Split-hand or Third-card drawing opportunities are able to book a Match play; if not at least a Double Down play for their hand(s). However, within the Propositions' Box, players can opt for at least a Triple Down action from such Proposition play which is why the Applicants in context moving forward, will identify the Secondary class of Propositions as; the “on menu choice” for Mufti-Down wagers and their events.

As for the electronic, wireless or otherwise means for play action, a player might well choose to play out each “Split-hand decision segment” upon a play action strategy wherein One (1) of each of the Split-hand(s) is wagered upon a “differing pay table menu of elevated risk” and all within the same round of play!

Similarly, as will be taught and latter claimed, there exists a great many possible play action embodiments for culminating the Applicants' gaming modifications that are applicable, especially as applied to electronic gaming applications, yet only a few of these embodiments will be cited for development as more exemplary counsels serving as the necessary disclosure hereto.

Therefore in reprise, traditional Blackjack is the most quintessential table game encompassing the psyche of the world's casino going experience. This is true even if you don't play the game. Almost nowhere will you go into a casino and not find Blackjack front and center stage! Indeed, from the Gaming industry's perspective; one only needs to look at “video Poker's” success over the years to see why the Applicants have so targeted their focus, and resolve, upon their game's deployment; via the dynamics of the numerous video platforms that are readily available.

As for the Gaming industry's behavior over this last quarter century or so, as new innovations for this perennial favorite “Blackjack” have arrived on the scene, it is astonishing to the Applicants' that so few of the art's previously taught methodologies modifying classic Blackjack's play have seen to aggressively redress the compounding historical affects of this fast changing industry upon the Blackjack workhorse at large, as the Applicants will continue to demonstrate, herein.

So instead, the public is offered 6 to 5 payoffs for not only single deck Blackjack games, but from mufti-deck shoe games too, and yet no alternative recourse for the player's action is offered.

At least, this is how the circumstances are viewed by the Applicants and particularly, as one might strategically “tune up” this game for the purposes of recalibrating, and maligning, this game from its core mathematical vantage point given the ever growing and smarter player population that today, so exploits the thinned down margin circumstances historically playing out upon the classic game's core mathematical dynamic, as all previously developed and cited.

Of course, these historical and contemporary observations are notwithstanding the competitive, yet concertedly empirical “rule change” decisions of Housemasters both good and bad alike from impacting the bottom lines of their own Blackjack games during this same generation, or so period of time as again aforementioned.

So from the Applicants' perspective, there is an alternative to the present day thin-in-the-math “adversarial” circumstance for which traditional Blackjack has historically operated. Therefore by way of such a redress, the Applicants' methodologies of “stripping out the dealer hand effect” to engage their Trigger Number Solution in its place, along with the uses of Standardized or Carnival/Spanish type decks, clears the way for charting a new recourse for Blackjack style play action (i.e., making new rules) as well as establishing a new core mathematical dynamic (i.e., setting new payoffs and HA values) that are competently capable of moving in along side the traditional Blackjack franchise as a most viable companion gaming option!

And as such, their alternative processes therefore results in a more mathematically malleable House Vig-advantage working amidst its play. In that the Applicants' balanced modifications deploy a never before applied synergy of “ameliorating consequences” by way of a wider “core margin variance” for casino's to work with. All of which is made possible through the abrogation of all the historically narrowing and binding effects of the adversarial mathematics that so systemically “chokes off” the traditional Blackjack methodology's ability to cultivate a more malleable working core margin advantage along with subsequently better payoffs for the player's consumption.

Similarly, the Applicants' methodology of replacing the dealer's hand in play, with their powerful “Trigger Number Solutions” operating within the play action of their game, so fundamentally broadens the mathematical margin being applied by way of the Applicants' modifications; that a richer statistical pool is the first ameliorating improvement from their process. And this result, already occurs from the Standardized Fifty-two (52) card decks being put to play, not to mention the introduction and use of either Carnival or Spanish decks being applied, whereby allowing for “fatter” payoff ratios, benefiting patrons without casting strenuous financial effects upon the House or worse yet, chasing off patrons with too strong of a core Vig-advantage.

For example, the Applicants' No Dealer Hand gaming methodology establishes a core Vig-advantage of about 2% at its Base play action over its players, while simultaneously establishing said “richer statistical pool” (from the core margin) for paying much fatter payoffs to winning hands. As such, this roughly 2% House Vig-advantage over all players from the Standardized Fifty-two card deck is more than three times that of the assumed average Basic Strategy player's results of frequently less than 0.49%, a circumstance for which most casinos will find advantageous.

Rule for rule, card for card, and to the payoffs, the Applicants' methods reveal a profound mathematical shift being integrated from the core of their game, thereby benefiting everyone!

Most importantly, the Applicants' modifications of removing the adversarial mathematics in support of having no “dealer's hand” and supplanting said dealer's hand with their Trigger Number solution, is by “de facto” the very inducement for the core statistical shift even being made possible. Likewise, this broader margin is made possible while simultaneously applying a seamlessly familiar playing experience for patrons regardless of the particular deck configuration being used.

In addition to this, the House is advantaged by way of the dissimulation of the “collective mind” that is so commonly used by Advantage-Players organizing against the Dealer's hand within the table gaming environment they occupy.

Meaning, in all to many Blackjack games these days, at least one of the six or so players is frequently a strong Basic Strategy even an Advantage Player whose purpose is to use “polite banter” directly relating to the ongoing game to guide “any & all weaker players” as to the “what, when & how” of making the correct advantage plays, thereby creating a better than otherwise collective outcome frequently by pitching Bust cards to the dealer. The ongoing result of this is a functioning House Vig-advantage aggregating much closer to 0.49%, rather than to the more robust productive end of the spectrum at about Two (2) plus percent, respectively.

As applied to the Applicants' play action methodology, banter of any kind has no real measurable affect in orchestrating anything for the obvious reason that there is no dealer's hand to affect, or play off of!

Therefore, if the House Vig-advantage is 1.78% or say, 1.31%, 0.96%, etc. or some portion of a flat 5% fee for that matter, then simply put, that's what it is for everyone who plays! Also, from the player's standpoint, the Applicants' modifications remain simple requiring only routine knowledge and therefore mental engagement on the part of patrons to play and enjoy the game.

Likewise, patrons no longer face down the repeating Up-card Ten or Ace, the Double Bust effect or even the dreaded “Push” on what should have been a winning hand like Twenty, or worse yet, Twenty-one! Furthermore, for the first time in known history, Housemasters can pay a “Blackjack” at 2 to 1, and a multi-card 21 at 3 to 2, at the Base play action of the same game, if they wish, without going broke . . . This is what the Applicants mean by “fatter payoffs.”

A Fifty percent improvement over the traditional game's historical payoffs for a Blackjack or multi-card 21 while in addition to this, players are usually guaranteed at least even money payoffs on all “Pat” outcome tallies of “Twenty” (20) projecting from the Primary Base and/or Secondary play action decisions of the Applicants' gaming process when used as a Winning Numbed

As for Nineteen (19), when used as a “Push Number,” the House has a built-in a safe spot for players assuming the House uses Nineteen (19) as at least a PN, if not a Winning Number, or as a “short-Win” Number (i.e. sWN), whereby the player wins half of the contract wager's total for the hand, rather than using Nineteen as simply a Trigger Number, for which Housemasters' certainly can do. As such, this significantly more malleable core margin Vig-advantage working within and from the Applicants' “Initial and/or Base” action for play is a direct consequence of the Applicants' fundamental insertion of their Primary Trigger Number solution into the process that so ameliorates a player's Time-In-Play too!

Another aspect of the Applicants' methodology is the ability of Housemasters' to “use and manipulate” the Primary & Secondary Base Trigger Number feature as required, meaning there are many pay tables from which to choose covering many wagers on the menu, whereby further massaging the Applicants' gaming process for their casino's financial benefit.

This is an achievement the traditional adversarial dealer's hand game of Blackjack with all of its underlying mathematics could never hope to orchestrate . . . Additionally, play actions like Surrender can also be accommodated for, albeit, its application works a little differently than traditional Blackjack Surrender does.

Therefore, as will be shown, several of the Applicants' many possible Secondary Decisions class of play action pay tables, being made operable from the games core mathematical function, are of a progressively intriguing persuasion of elevated risk, as is especially demonstrated, regarding all of the new player menu recourses being further disclosed in detail below.

Clearly, the Applicants' new player recourses like those provided through the tag-along designed “Ante-up Joker's Jackpot” which will be frequently wagered simultaneously, as the player books for simply; a “Lo hand-count Card Drawing March, or LCDM” and/or the “Joker's CDM or JCDM.” Also, there are the fantastic “Parlay re-play hands,” now available in the mix of new player options. All of which, are directly compatible with the Applicants' earlier formulations & disclosures.

### OBJECTIVES AND ADVANTAGES

Accordingly, several objectives and advantages are clearly achieved by way of the Applicants' method of having No Dealer Hand being applied throughout their process of play. First, regarding the “Table Game” process of play, the Applicants' methodology calls for the complete abrogation and replacement of the dealer's hand in play.

The Applicants accomplish this through means of their Primary and/or Secondary Base Trigger Number effect, again defined as singular, grouped or sets of numbers, typically but not always numerically preceding the Push and/or Winning Numbers as applied in the Applicants' process for play. Trigger Numbers will range anywhere from: Twelve (12) up to Twenty (20) and can substantially “fluctuate” in their financial impact upon the players starting at the Primary Base action of the game for a couple of reasons.

One reason is due to the way the completed hands fallout from the shuffling mix of the deck or shoe, while another reason is more attributable to all Primary & Secondary Base and/or Secondary Propositions' Box play action Trigger Numbers in uses that may bear fluctuating “Vig” values as well. This fluctuating Vigorish does play a “freer roll” within the electronic transmission methods for play action as will be further developed below.

Furthermore, this fluctuating Vigorish is notwithstanding a decision by Housemasters' to engage a flat fee percentage commission solution being “grafted” in as either an addition to the core mathematics margin already at work, or as an application to both winning Primary and/or Secondary Base play action outcomes or again, just as applied to the winning Secondary Propositions' class of outcomes. Similarly, decisions to engage only a commissionable percentage due fee solution for either an individual Primary or Secondary Base WN and/or sWN selections, or as applied, to a range of Proposition WNs and/or sWNs shall be further reviewed below as well.

As for the immediate fluctuating impact upon the players when Standing Pat on hand counts of Twelve (12) up to Twenty (20). Only the practical uses of monetary units (i.e., Chips), as applied to “live action” table gaming applications, along with the same widely accepted mathematical mechanics as to be applied to such live action play with such monetary units, as well as the commonly accepted mathematical mechanics for electronic gaming platforms shall be the guiding factors in determining the House Vig-advantage edge of a TN selection as they are applied from: Twelve (12) up to Twenty (20) and/or optional PN selections from: Twelve (12) up to Twenty (20), and typical WN or sWN selections of up to Twenty-One (21) being put to use.

In addition to this, and as expected, Housemasters' shall be the arbiters regarding the use and deployment of their casino's deck configurations in play. As planned for, through the uses of either Standard decks, Carnival and/or Spanish decks, etc., the Applicants' No Dealer Hand methodologies apply the application of Standard Fifty-two card decks, with or without Joker cards being used, and further envisions Carnival decks as having either, the “Red or Black” Ten (10) Pip-cards being removed, with possibly the two (2) Joker cards being put in as replacement, whereby exacting a wide degree of valuation and purpose from such Jokers being applied in play.

Similarly, Housemasters might simply elect to remove the red or black Ten (10) Pip-cards alone, without engaging Joker replacements, whereas the Spanish-type decks, have ALL Ten (10) Pip-cards removed with Joker cards optionally being distributed into their place.

Moreover, as in any game, deck configurations bare considerable influence in the core margin analysis of a game's overall House-Advantage-edge. As this is true for the game of Blackjack at large, and will also be the case, for the Applicants' No Dealer Hand 21, methodology.

Additionally, Housemasters through both “live action” table gaming methods including organized tournaments as well as through electronically mechanized gaming equipment, inclusive to “third party” hand held wireless devices too, might well adopt a commissionable percentage due fee and/or point structure for a win/payment/prize application to winning wagers or point totals being accessed for payout/award from particularly, but not limited to, the Applicants' Secondary Decisions Fork and menu of application.

Clearly as one can already see, several differing yet cohesive aspects of the Applicants' process for play can arise among this range of deck configurations, and the TNs, PNs, WNs & sWNs, being applied for play action from: Twelve (12) to Twenty-One (21), respectively.

For example, if a given casino was to counsel the use of: Seventeen (17), as their first Primary Base selection of a TN being used, this would leave Standing Pat on every hand count “short” of Seventeen (17) as being “Sacked”. Meaning, the player loses their entire wager while each and every player hand count tally over Twenty-One (21) are Busted, therein losing their entire wager(s) as well.

In even another example, if Housemasters' counsel the Primary and/or Secondary Base

Trigger Numbers to be: 16 thru 18, with 19 as a Primary and/or Secondary Base action Push Number and 20 & 21 as the Winning Numbers, then all player hands Standing Pat on Fifteen (15) or less, would be Sacked for a complete loss as well, and so on.

As a practical matter, this situation of getting Sacked will only occur when a player succumbs to Standing Pat with a hand count short of the established “first” Primary and/or Secondary Base play action TN or the Secondary Proposition's TN being used as with a short hand count tally from a weak Double Down and/or Mufti-Down action, or a weak draw on Split Aces or Parlay hands should players only be allowed One (1) card for each Split Ace or for each card of a Parlay hand.

Again by definition, a Sacked hand count within the realm of the Applicants' process for play is any hand count that is not Standing Pat upon at least the first Trigger Number among the selected TN's being applied to the game, whatever they might be, Primary and/or Secondary Base TNs or Secondary Propositions' Box TNs.

Therefore, beginning with the dealing of the cards, all players are dealt Two (2) cards. Then starting with the person sitting at first base on the table, each player seeing the value of their present Two (2) “hole” card hand tally have fast decisions to make; do they “Surrender,” “Draw” card(s), “Stand Pat,” “Double Down” and/or “Split” their cards, including Splitting their cards for Double Down play action(s), all of which begin as Primary & Secondary Base play actions.

Or, if perceived make able, do players assume the greater risk of the Secondary “Propositions' Box” be they for Split-Hand, Multi-Down or even Multi-Down plays on a Split multiple of hand(s), including the application of the new Parlay Blackjack & Parlay 20 hands.

As for these new Parlaying re-play events, these wagers are “Post-paid” Parlay action events meaning; once the first winning Blackjack or a winning two-card Twenty (20) shows in play, and is subsequently paid-off the player is then “prompted” to execute this new phase of optional play. Such play is; the Parlaying-Split and replay of the original two-cards involved for either type of hand. In so doing, the player is then able to increase each new hand up to; Triple their original bet, and draw One (1) card for each new Ten (10) or Eleven (11) count hand in play. Match-play & Double in the Base or Match, Double and/or Triple Down in the Prop-Box, where pay-offs are guided by the more aggressive Propositions' play action regimes, as being called-out upon either the tabletop or video interface. Each hand stands to win, lose or tie, according to the pay tables being applied.

In actual play action, any Secondary Decisions class of wager moving up into the “Propositions' Box” wagering area, is readily identifiable upon any “No Dealer Hand” game table layout whether increasing an initial wager(s) or booking a new wager, while exposing said wager's completed hand to; a significantly greater risk & reward event from what they would otherwise experience within the “Base play action” of the game alone!

So, in a nutshell, the idea and application of the alternative Secondary Decisions regimes, is to accommodate the Applicants' unique discovery for allowing players to reach for the casino's “Chandeliers,” as it were. Subsequently, the Applicants' Secondary Decisions process also allows for each player, to reconsider and re-engage the status of their “initial Base” wager(s) starting the hand. Meaning, after booking their first contract wager, and viewing their first two (2), hole-count cards. Therefore, should a player desire to increase their wager(s) a new method now allows for such an action before drawing additional cards, and as such, defines; a “Lo-count Card Drawing March” or LCDM, via the Secondary Decisions process starting from the player's initial Lo hole-count hand(s).

Additional to this process, is a compelling, specialized means for action being made available through the redemption of Joker cards, and will likely become a useful “enabling factor” when allowing for Joker CDM's through the Secondary Decisions menu. However, “Card Marches” can occur at will, and without Jokers, by players who bear the added risk . . . Pay tables dictate outcomes!

Remembering, the Secondary Decisions regime is all about the Secondary Base vs. the Proposition Box's choice for play actions. Furthermore, players can, and will, utilize both paths for Secondary Decisions, when engaging all of their differing Ten (10) & Eleven (11) count hands, Splitting and Multiplying Down on paired Aces or even the Ace-Ten Blackjack and Power 20 Parlays, as they come into play, when drawing the usually One (1) card allowed for executing many of these play action(s), wherein the player is hoping to redraw to at least a Twenty (20) count hand again, if not, a Twenty-One (21) outright for payoff. And, now we're adding two types Card Marches and, an Ante-up Jackpot to this mix of options . . . As this all assumes, the Player is willing to withstand the elevated risk of getting Sacked or Busting as the circumstance may play out.

The lure for such play, is the numerous starting hands that are already half-way to a strong Parlay play event or, are great plays for increasing their original starting wager of a hand, too include, dealing effectively with either “Lo” hole-count draws or Stiff-hand draws starting a new round. However, restrictions upon Tens (10) & paired Fives (5) for all CDM actions, may be applicable . . .

Therefore, the Applicants' unique methodology model(s) provide a “whole new” outlook directly supporting most all of the aforementioned features and benefits from their game's core mathematical mechanics. As such, Housemasters' can moderately increase or decrease the game's critical core operating margins in addition to the margin-costs of applied rules for play; starting with the affective choice of deck configuration, and this all before the first card is ever disclosed in play.

In addition to all the above citation, here are just a few clarifying examples regarding the uses of differing deck configurations, when engaging Joker cards, for either the electronic or physical table game application. Typically, the broadest range of allotments would be “up to” Two (2) Joker cards being applied in play, per deck in uses, or say within an Eight (8) deck shoe; this would allocate “up to” Sixteen (16) Joker cards for uses in play, etc.

First, Jokers, whatever there numbers in uses, can be applied as “free-uses wild-cards.” The methods for Joker card acquisition can come to the player either by way of the player's first Two (2) hole cards, at the start of a new hand, or from the random draw of cards during the course of playing a hand. In all cases for this scenario, the Joker cards are immediately replaced with the very next card off the deck, or shoe. Now, such Joker cards are “held for the player” to then be redeemed in a future hand, of the player's liking.

And second, Joker cards become both a tool and means, for allocating an optional increase to said future hand's initial contract wager having been put into play. Through such a redemption cycle, of said Joker cards; a “Joker's Card Drawing March” or JCDM, is then ensued through either the Secondary Base action of the game or one of the Secondary Prop-Box's menu of pay tables.

The mechanics for such Joker card redemption in practice begins by the player establishing a new wager in the Base play action of the game this is followed by the player acquiring a new two-card hole-count hand. Next, if the player decides to act, “they advance (slip) a ‘presently held Joker card to be redeemed, face-up’ under the existing contract wager,” whereby then further being moved to the Propositions' Box or left upon the Base wagering area; according to the player's choice and appetite for risk! It is then the player, is allowed to increase the contract wager on the table. At least, Triple Down events will be common. Next, the two hole-count cards already being shown for the hand, begins the Joker's CDM . . . win, lose or push. In strategy, the lower a hand's hole-count the better for either type of CDM's play action. For example, should the new hole-count hand be a “Lo-count” (i.e., A-A, A-2, 2-3, 3-4, 4-4 etc., not >9) or some other small pair, should the player have more than one free-uses Joker card, or one of the lower Stiff hand-counts (i.e., 12, 13 & 14), these are the “best opportunities” to consider any CDM actions in cycle. Therefore, if, another new Joker shows upon the draw, while engaging such a redemptive action with a cumulative hand count that has yet to Bust, this results in an “instant winning draw” of at least an even money payoff to the player. All winning CDM's pay small fees in support of Jackpots.

This result stands, regardless of the accumulation of cards being drawn, be that one card or ten cards, as long as the “player stands or a new Joker shows before Busting-out.” Players win either type of CDM in one of three ways, by drawing to a: sWN, WN or a new Joker shows in the draw! The choice of wagering location for either LCDM or JCDM play is CRITICAL regarding the overall ancillary playing conclusions, including; any uses of TN's, PN's, sWN's and WN's being applied.

Another aspect of the CDM is there direct financial support for the Joker's Jackpot As the player books either the more aggressive LCDM's or the less aggressive JCDM's, each winning payoff engages a small “X” % fee upon their winnings, over the working HA in the wager. All CDM's can “Ante-up” for the Jackpot . . . The Joker's Jackpot is a Side-bet, that accumulates into an uncapitated Jackpot via “Fees & Antes”. Therefore, its through the “Fees” cast upon all winning CDM's and specifically, as players make the additionally required Jackpot “Ante-ups” incumbent upon anyone playing for the Jackpot (equal to a “hefty portion” of their initial contract wager) that the means for continuous “post-win replenishment” into this typically “twin-event's play cycle” is maintained.

Players can WIN this twin-event, inclusive to either CDM, along with the Joker's Jackpot, if, a winning point count of exactly Twenty-one (21) shows . . . All other WN, sWN or Joker-to-show outcomes,” will result in a win, yet only according to their respective pay tables. However, in this scenario, the player still “fails to win” the Joker's Jackpot! The House will typically exact an “X” % rake, upon the Jackpot's running total prior to every winning payout, as an administrative fee.

Another uses . . . should both a Joker and an Ace come together, as an initial hole-count pair, is an instance that could call for the Joker to become “wild with that Ace,” for an immediate bonus payoff Also, not to be overlooked, should a “Pair of Jokers” show in an initial Two (2) card hole-count hand, wherein such a showing could easily comport into a “first two-card Ante wager,” this too, could pay a special bonus payoff while leaving said Joker cards, to still be redeemed later.

Actually, Housemasters can and will, create and apply, many differing methods and purposes for Joker card deployment(s) as they see fit, with their many simultaneously corresponding rules and/or Fees & Antes along with the consequences of there respective pay tables being applied . . . Nevertheless, should a player's first Two (2) cards tally to a Stiff hand (i.e., a 12, 13, 14, 15 or 16) that is less than the selected set of Primary Trigger Numbers (i.e., 17-18-19) for the table's uses, the player(s) may then elect to Surrender and “Stand Off to a Push,” meaning the player does not win or lose as Surrender is defined within the Applicants' process; assuming Surrender is available at all.

However, any established “Ante” wager Side-bets would most likely fall to the House as a consequence of exercising such a Surrender option. Likewise, the Surrender option as applied may well prove subservient to additional factors like; No “back-to-back” Surrender and/or No Surrendering on a “Trigger” range of numbers Seventeen (17) up to Nineteen (19), and/or No Surrender after a third card is drawn, or even to include, No Surrendering upon “newly progressed” (increased) wager(s), all in example.

In further reprise regarding Secondary Decisions regimes to draw cards; since the Applicants' process for “21” play is unique in that if on the one hand, a player's first Two (2) hole cards tally to less than the selected Primary or Secondary Trigger Numbers (i.e., 17-18), players are then certainly compelled to draw at least One (1) card under many given situations. This is due to the fact that a player's hand count lies in a Sacked condition at this point, and therefore the player will lose their entire wager on any standing tally count of Sixteen (16) or less, for this example.

This again assumes the player did not exercise their first Two (2) card Surrender option, which may have been available to them, and is notwithstanding the player drawing to a Sixteen (16) or some other Sack numbers lying in wait to be applied in a Secondary Base Double Down play action or some other Secondary Propositions' Multi-Down action the players may have made.

Once more, on the other hand, should a player's first Two (2) cards or any number of cards for that matter tally to; Sixteen (16), Seventeen (17), Eighteen (18) and/or Nineteen (19) which can often represent a typical selection of Primary or Secondary Trigger Numbers being used in execution of the Applicants' game, these players are then “hanging on the Trigger”.

Surely, when players are caught hanging on the Trigger, they still might want to draw at least One (1) card due to the fact that “Standing Pat on the Trigger” will cause a player to lose a “hefty portion” of their contract wager presently at risk for the hand.

Of course, the risk of Busting, over Twenty-One (21) is confronting the players in this circumstance too, which instead would result in the complete loss of their wagers.

In further development of the Trigger Numbers application at least within the Applicants' electronic processes for play, Housemasters' might well call for the “expansion or retraction” numerically of the TN affect, “even on the fly of action,” either by including Sixteen (16) or say subtracting Seventeen (17), as just one example. Or for example, arbitrarily loosening and/or tightening, “even on the fly of action,” the application of the House's fluctuating Vig-advantage percentages for such TN's projecting from any Primary and/or Secondary selection of Trigger Numbers being applied as well as their winning payoff regimes. Clearly, such play options will likely operate in their greatest dynamic capacity as applied to the Applicants' electronic applications.

In addition, Housemasters' might well see a reason to utilize numbers like Eighteen (18) and/or Nineteen (19) as optional Push Numbers, at least within the Primary and/or Secondary Base play action, or as applied to both types of CDM's, instead of just simply using them as Trigger Numbers, in example. The Primary Trigger Numbers in uses would then be 16, 17 or 18, or maybe just 17 & 18 respectively, along with their “biting Trigger values” for the House.

Therefore, in this example, at least 17 & 18 are the Primary TNs while 19 is functioning as a Primary PN thereby leaving 20 & 21 as the WNs. Additionally, and as aforementioned, a reduction in the Secondary selection of Trigger Numbers from 12 up to 20 could also be used for Double Down and/or “higher risk” Multi-Down menu of actions or as applied to CDM's, as well.

The more aggressive LCDM for example, could easily look something like this . . . Say, a player draws a two-card hand beginning with a pair-of-fours, and by definition, the player is making an LCDM play, so this player has “no Jokers working” for the hand. Therefore, he begins his “March” from One (1) of his first Split-fours, or a single combined hand of Eight (8). Next, the player begins to draw cards . . . The first opportunity to stop drawing cards comes arbitrarily on say Sixteen (16), then again on Eighteen (18), where these two outcomes are playing as “Push Numbers” for this action, thereby leaving “Twenty-one” as the single target WN, winning “X” to 1, in payoff!

All other possible outcomes loose! This is an aggressively exciting play and if the player also Tripled Down before starting out on this LCDM event, times Two-hands, along with his “Ante-up” wager(s) for the “grab” at the Jokers Jackpot play action too, well then, a very BIG WIN is at hand?

Furthermore, it is by this very means of the Applicants' Primary and Secondary Base and/or Secondary Decisions Trigger Number feature along with the companion manipulations, of the payoffs made on sWNs, WNs or, those Joker-to-show outcomes for application upon JCDM's, for instance, that the ameliorating power dynamic which so significantly transitions the House's advantage margin across the game's numerous play action options, is made.

Likewise, either of the Applicants' aforementioned Primary or Secondary Base and/or Secondary Propositions' play action selection of TNs, whatever they are established to be 17 & 18, or 16, 17 & 18, or just simply 19 for that matter respectively, are also subject to an “adjustable” and fluctuating percentage for affect as also just delineated.

Meaning, each TN is either subject to the same static Vig-advantage affect in its individual/group number setting for play action (as will be commonplace for table gaming action), or players may realize a rising escalation or fading reduction of Vig-percentages affecting each individual TN number in its group setting by random electronic impulse, even as played out upon the fly of play action. Indeed, such options are particularly relevant to the Applicants' many cumulative electronic applications and wagers.

However, not only within the realm of “static” table play action, say a Primary Base selection of TN's: 16-17-18, all factor as a static 50% loss, or “Vig affect,” upon the players contract wagers when Standing Pat while a Secondary Base and/or Secondary Propositions' group of TNs affecting Base Split-hand Double Downs and/or Proposition Multi-Down actions might well bear a fading reduction or “Vig affect,” like: 60% on 16; 50% on 17; 40% on 18 respectively.

Or, for that matter, any number of productive solutions can be made to applied from expanding to retracting TNs, rising or fading Vig-percentages or just simply using fixed “static” techniques which are all processed within the same or similar core calculation mechanics of the Applicants gaming formulations as made acceptable through widely held mathematical procedures, and as ultimately displayed upon the House's numerous play option events, and there pay tables.

Therefore, it is directly through the Applicants replacement of the classic Blackjack “Dealer hand” method as initiated through the application of their Primary & Secondary Base Trigger Number solution that opens up such a significantly improved core margin variance for exploitation in the first place, as once again aforementioned.

As such, the Applicants' core solution provides a “whole new” outlook directly supporting fatter core payoffs starting from their Initial/base mathematical mechanics for play while still providing for all the necessary and creative elements of an interesting and sustainable alternative to the classic Blackjack workhorse for which the public will enthusiastically embrace.

Furthermore, it is the principle objective of the present method for No Dealer Hand “21” to provide a wholly new gaming process dynamic while requiring only routine mental focus to enjoy a seamlessly familiar playing experience.

It is another principle objective of the present method for No Dealer Hand “21” to provide a wholly new paradigm of thought provoking play that competently coincides with accepted mathematical mechanics and procedures regarding applied probabilities of chance projecting from the applied integrating core resources of first; the cards, along with their shuffle mix dynamic, and then their play action distribution.

It is another principle objective of the present method for No Dealer Hand “21” to provide a wholly new adaptation in the form of Primary Trigger Numbers establishing the Base consequence of play action that replaces both the action, and function, of the now absent dealer's hand in play.

It is still another principle objective of the present method for No Dealer Hand “21” to provide the application of a number of acceptably configured decks of cards or the electronic representation thereof, be they Standardized, Carnival or Spanish decks which can include the usage of Joker cards during their composite revelation to players, for which application thereof, provides a certain degree of mathematical volatility and value, being built into the basic functions of the game whereby Housemasters can apply many differing type of wagers and methods including for Joker card deployments and payoff regimes with their corresponding rules and consequences.

It is still another principle objective of the present method for No Dealer Hand “21” to provide for the engagement of Primary Base Trigger Numbers comprising any numbers from 12 up to 20 that can be expanded or retracted numerically to affect the game's volatility benefiting the House's core margin Vig-advantage via the Applicants' Base process for play.

It is still another principle objective of the present method for No Dealer Hand “21” to provide for the uses of a Secondary Base set of play action TNs comprising any numbers from 12 up to 20 that can be expanded or retracted numerically, as well as being loosen or tighten on a percentage basis, to effect the subsequent operational “win percentage values” for Split-hand and/or Double Down actions from the Applicants' Secondary Base option process for play.

It is still another principle objective of the present method for No Dealer Hand “21” to provide for the uses of a Secondary Propositions' Box play action TNs comprising any numbers from 12 up to 20 that can be expanded or retracted numerically, as well as being loosen or tighten on a percentage basis, to effect the subsequent operational “win percentage values” for Split-hand and/or Multi-Down actions from the Applicants' Secondary Propositions' Box process for play.

It is still another principle objective of the present method for No Dealer Hand “21” to provide for the engagement of optional Push Numbers comprising any numbers from 12 up to 20 that can be expanded or retracted numerically to affect the available pool of Trigger Numbers supporting the House's core margin Vig-advantage, resulting from the Applicants' process for play.

It is another principle objective of the present method for No Dealer Hand “21” to provide a wholly new paradigm of thought provoking play that competently coincides with accepted mathematical mechanics and procedures regarding applied probabilities of chance as applied through the additional adaptation of an optional commissionable percentage “Fee and/or House Rake” solution being exacted upon certain winning outcomes and classifications.

It is still yet another principle objective of the present method for No Dealer Hand “21” to provide for the engagement of TNs, sWNs & WNs that can be expanded or retracted numerically, as well as loosen or tighten, even on the fly of play action, upon an individual or group percentage basis, thereby supporting a rising or fading escalation of effect upon a House's “win percentage values” as applied to such TNs, sWNs & WNs within the Applicants' process for play.

It is still yet another principle objective of the present method for No Dealer Hand “21” to provide for the uses of Primary & Secondary play action sets of Trigger Numbers, Push Numbers, short-Win Numbers and Winning Numbers comprising any numbers from 12 up to 21 that can be expanded or retracted numerically, and/or loosen or tighten on a percentage basis, even on the fly of play action, whereby regulating the House's operational win/lose cycle, therein benefiting said House's subsequent operational “win percentage values” from such TNs, PNs, sWNs & WNs in uses during play that includes application into the Applicants' Secondary Decisions process.

It is still another principle objective of the present method for No Dealer Hand “21” to provide for the engagement of the Applicants' Secondary Decisions process that allows players to reconsider, and increase the amount of their “initial Base contract” wager(s), after viewing their first two hole cards, whereby if a player desires to increase such wager(s), this method now allows for such an action before drawing additional cards, therein defining; a specialized Card Drawing March method (a.k.a., CDM), being applied through said Secondary Decisions' menu and process inclusive too, the useful application of any; TNs, PNs, sWNs, WNs or Joker cards being applied in play.

It is still another principle objective of the present method for No Dealer Hand “21” to provide for the engagement of the Applicants' Secondary Decisions process that allows players to reconsider, and increase the amount of their “initial Base contract” wager(s), after viewing their first two hole cards, whereby if a player desires to increase such wager(s), this method now allows for such an action before drawing additional cards, therein defining a specialized Card Drawing March, of which said March, is to further include; an additional means for exacting a small percentage fee from any type of winning CDM to financially assist in the fueling of this method's additional Jackpot component as now being applied through said Secondary Decisions' menu/fork and applications.

It is still yet another principle objective of the present method for No Dealer Hand “21” to provide for the additional proprietary adaptations of the Applicants' Secondary Decisions process, that allows for the acquisition of an additional “Ante-up” wager as a means whereby players also make themselves eligible for an additional Jackpot payoff upon a winning hand of “21” points.

It is still yet another principle objective of the present method for No Dealer Hand “21” to provide for the additional proprietary adaptations of the Applicants' Secondary Decisions process that allows for Housemasters' to typically exact at least an “X” % rake, upon a Jackpot's running total prior to each winning pay-out, as an administrative fee.

It is still yet another principle objective of the present method for No Dealer Hand “21” to provide for the additional proprietary adaptations of the Secondary Proposition types of Multi-Down play action events including; Parlaying of Blackjack hands and initial Two-card Twenty (20) hands, offering much higher payoffs being projected through the Integrated core mathematics of the Applicants' card play methodologies.

It is still yet another objective of the present method for No Dealer Hand “21” to provide for a redefined adaptation for Surrender, as an option of play, that functions in play action as a “stand off” solution alternative for an initially dealt Two (2) card Stiff hand of less than the first Trigger number being applied in play action.

It is still yet another objective of the present method for No Dealer Hand “21” to provide for an additional assortment of ancillary “Ante” wager type Side-bets for bonus payoffs, upon the outcome of the first Two (2) or Three (3) cards of a hand being dealt from which players can choose.

It is even another objective of the present method for No Dealer Hand “21” to provide casinos' with a gaming mechanism that can be manipulated to result in a more sublime manner, while ameliorating the affects upon a patron's Time-In-Play.

Another consideration regarding the Applicants' process for No Dealer Hand “21” is to make their gaming modifications available for application into an encompassing electronic video display unit being of a community based and/or singularly intimate nature or third party hand held wireless devices and the like (not shown), whereby a more complete and sensitive, “even mill-able scale of credits distribution” can be used for either or both of the Primary and/or Secondary Base Trigger Number selections or Secondary Decisions' menu of TN selections being applied, along with the application of optional Push Numbers, short-Winning Numbers or Winning Numbers being comprised from Twelve (12) up to Twenty-One (21).

### DESCRIPTION OF DRAWINGS

The foregoing features, advantages and other objectives of the Applicants' methodologies and modifications will become even more clearly understood from the following flow of decision chart embodiments for progressive events as taken in conjunction with the accompanying “description of counsels” (rules for optional play) encompassing any physical table game and/or Electronic video or even wireless broadcast gaming display apparatuses being applied for the same.

FIG. 1 Illustrates the general flow of progressive decisions/events to complete a round of play ,for the table game version of No Dealer Hand “21”.

FIG. 2 Illustrates some of the many possible, first-two-card “Ante” type wager Side-bets.

FIG. 3 Illustrates the means and methods for engaging the “Parlay” re-play hands during play.

FIG. 4 Illustrates some of the many possible, first-three-card “Ante” type wager Side-bets.

FIG. 5 Illustrates the detailed means and methods for engaging the LCDM & JCDM wagers.

FIG. 5a Illustrates the detailed means and methods for engaging the “Joker's Jackpot” wager.

FIG. 6 Illustrates the detailed flow of progressive decisions/events to complete a round of play, for the electronically mechanized and/or wireless device platforms for No Dealer Hand “21”.

FIG. 7 Illustrates the Primary & Secondary Decisions menu of actions for No Dealer Hand “21”.

FIG. 8a Illustrates a first exemplary counsel embodiment with there predetermined payoffs.

FIG. 8b Illustrates a continuing first exemplary counsel embodiment for play action.

FIG. 9a Illustrates a second exemplary counsel embodiment with there predetermined payoffs.

FIG. 9b Illustrates a second continuing exemplary counsel embodiment for play action.

FIG. 9c Illustrates a second continuing exemplary counsel embodiment for play action.

FIG. 10a Illustrates a third exemplary counsel embodiment with their predetermined payoffs.

FIG. 10b Illustrates a third continuing exemplary counsel embodiment for play action.

FIG. 10C Illustrates a third continuing exemplary counsel embodiment for play action.

### DETAILED DESCRIPTION OF EXEMPLARY EMBODIMENTS

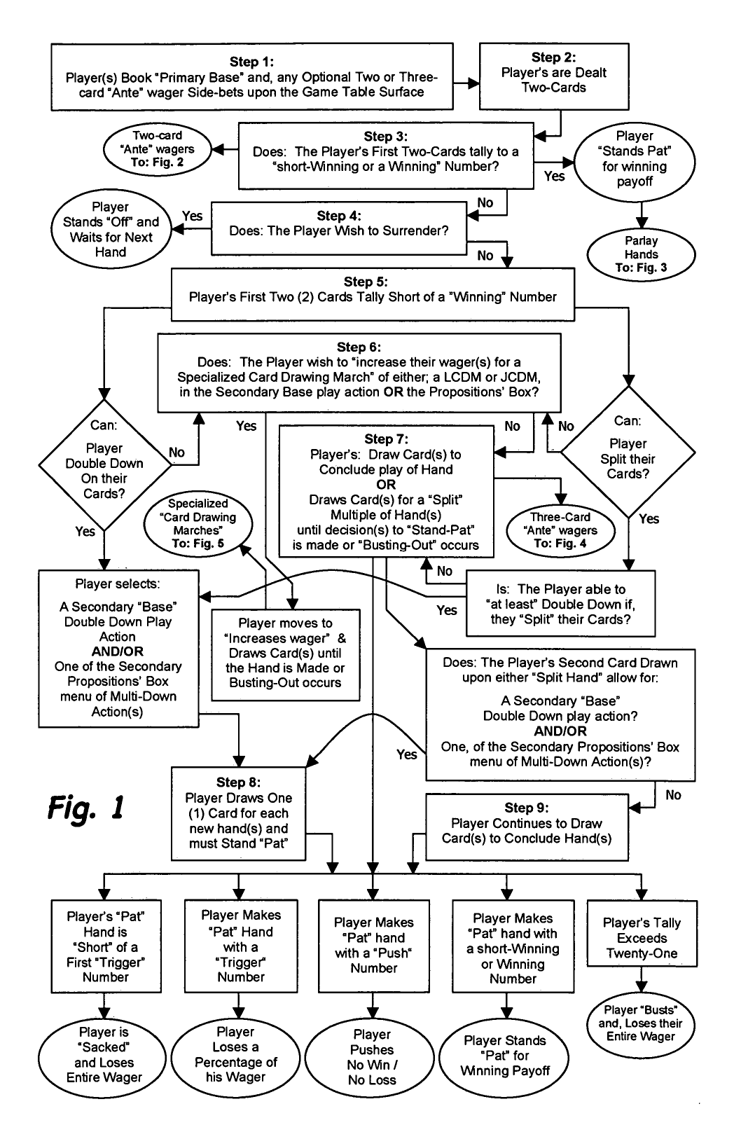

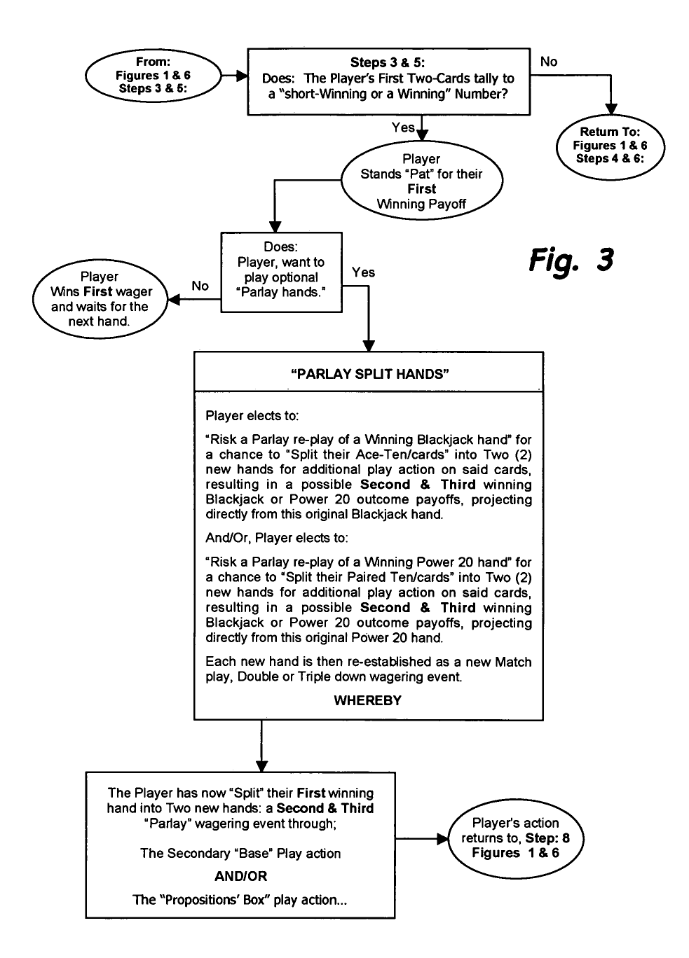

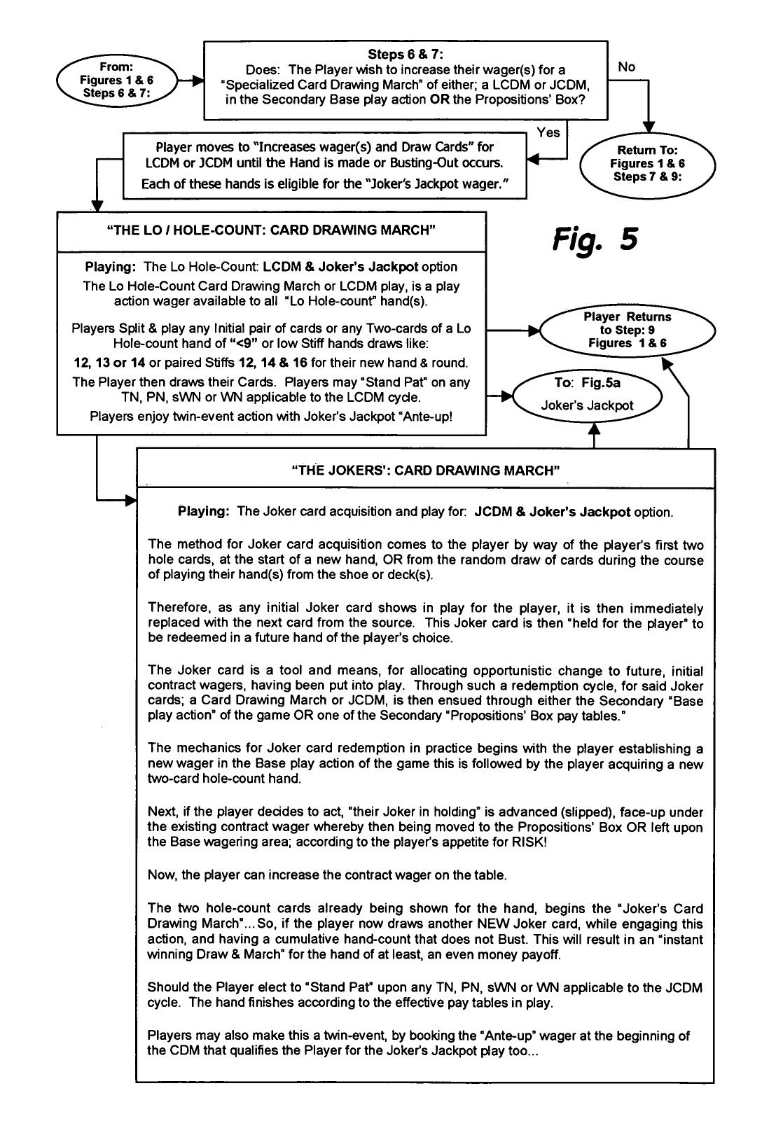

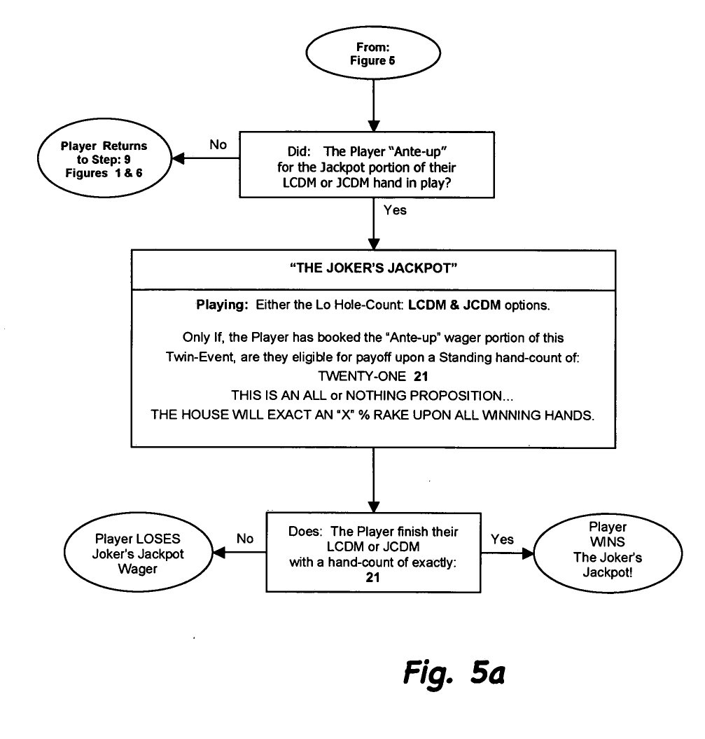

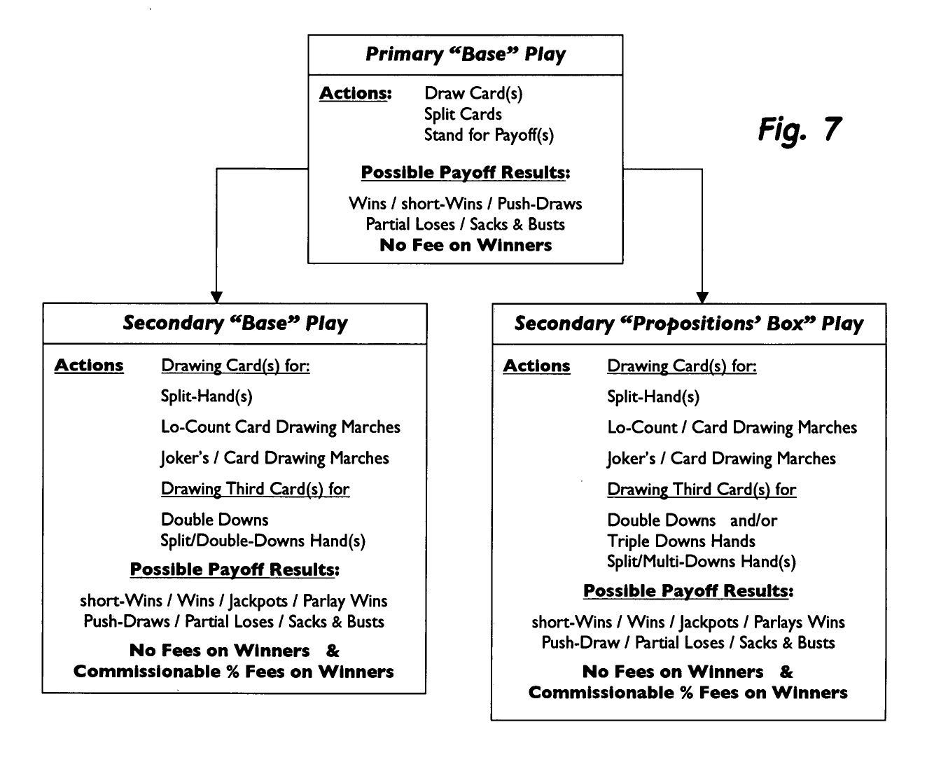

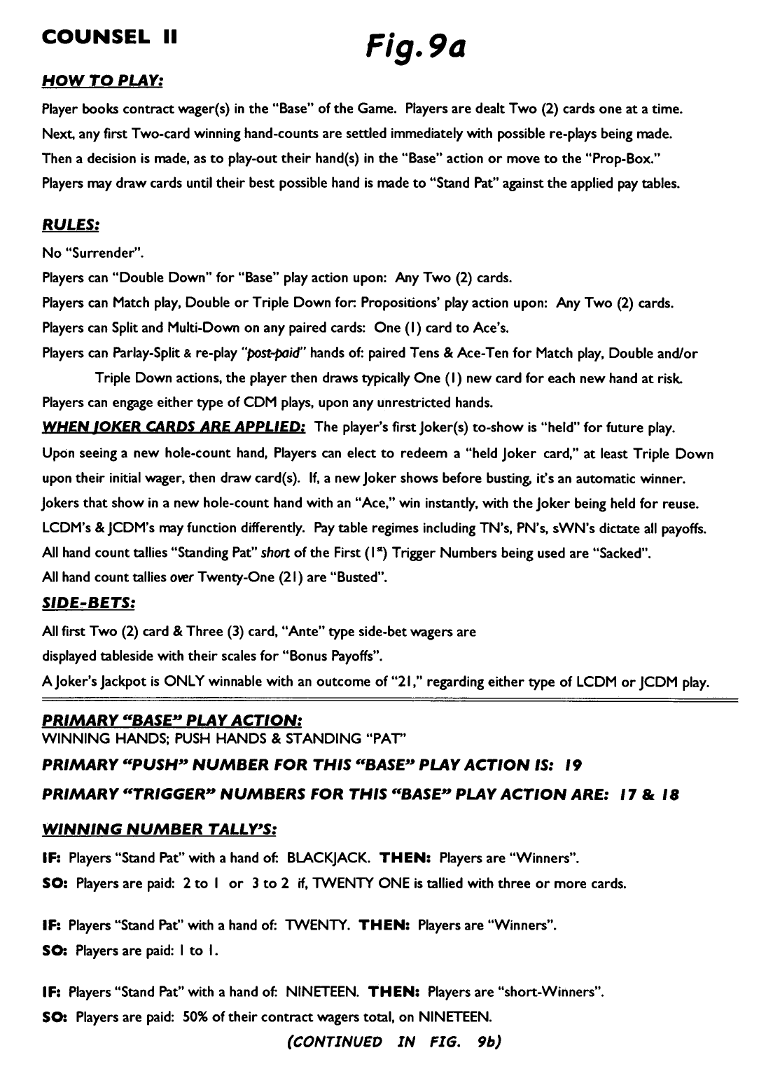

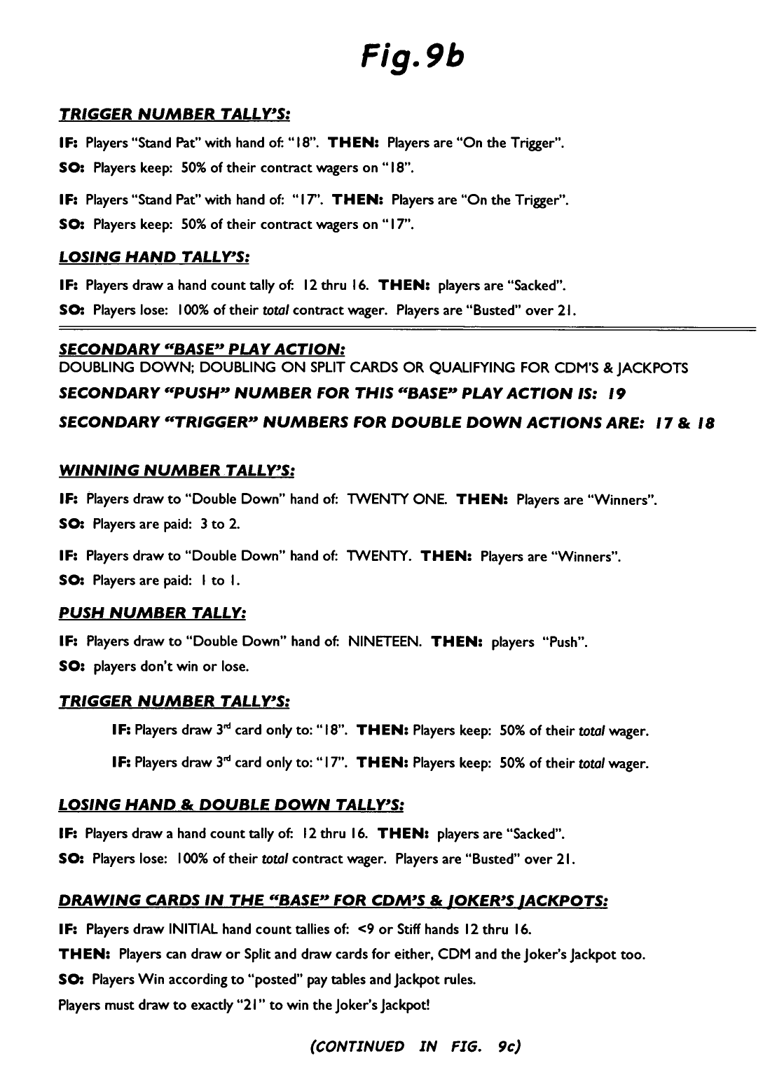

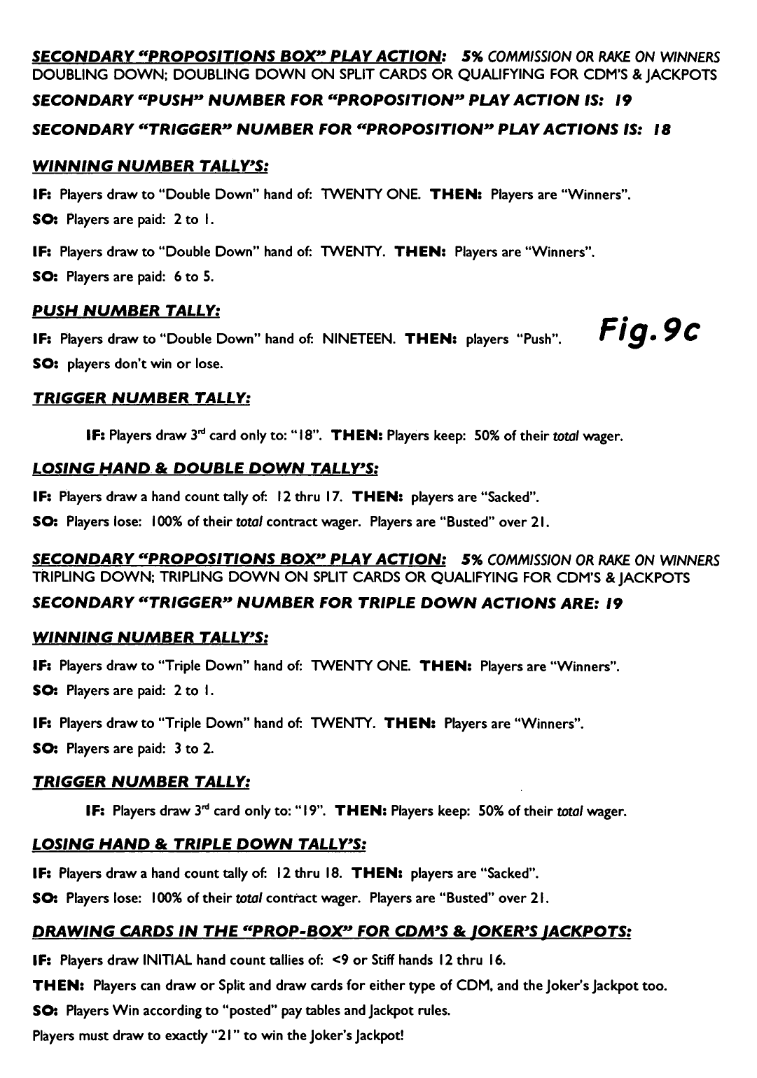

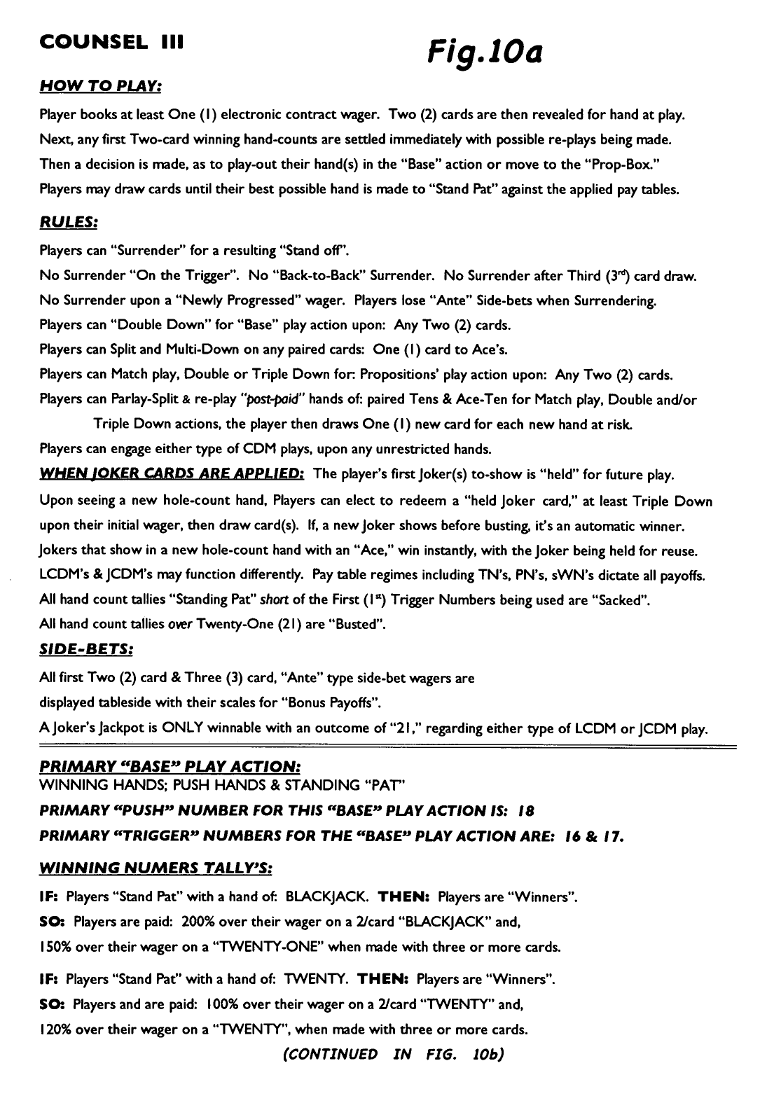

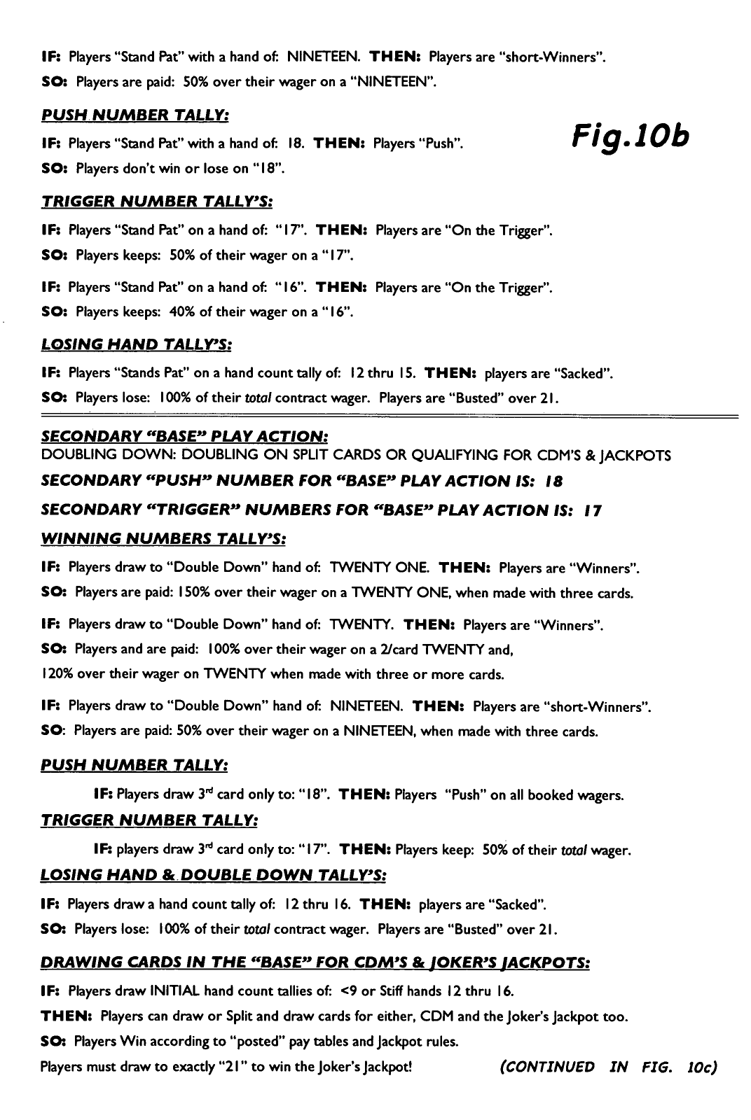

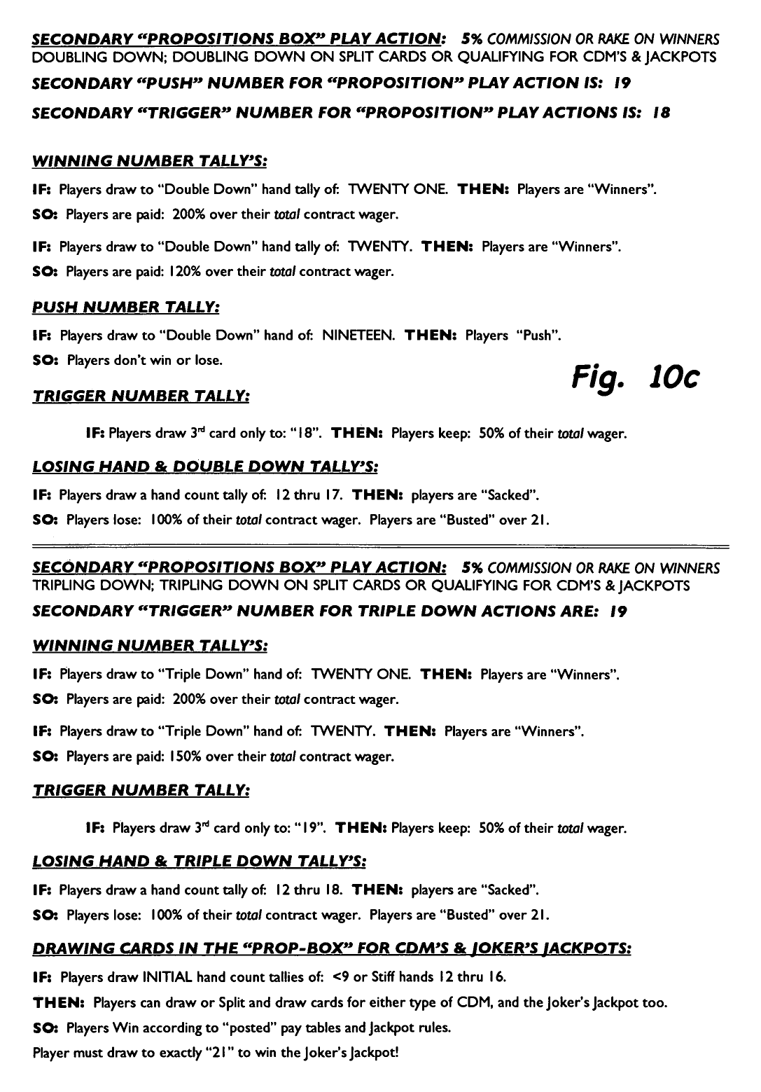

In referring to the drawings as illustrated, it shall be understood that the combined entities of FIGS. 1 through 10c inclusively are exemplary embodiments of the Applicants' gaming methodology. As such, any and all of the Trigger Numbers, Push Numbers, short-Winning Numbers and Winning Numbers as selected, discussed and/or illustrated are subject to change at the whim and purpose of the sponsoring organization (casino).

This pertains to their numerical associations to one another as well as their established Vig-advantages, even as assigned on the fly of random algorithmic design by Housemasters.

Likewise, all methods for public access to the Applicants' “No Dealer Hand” gaming solution, be they “live action”, electronic video, wireless communications, mobile Internet devices or otherwise, represent anticipated deployment avenues for this game.

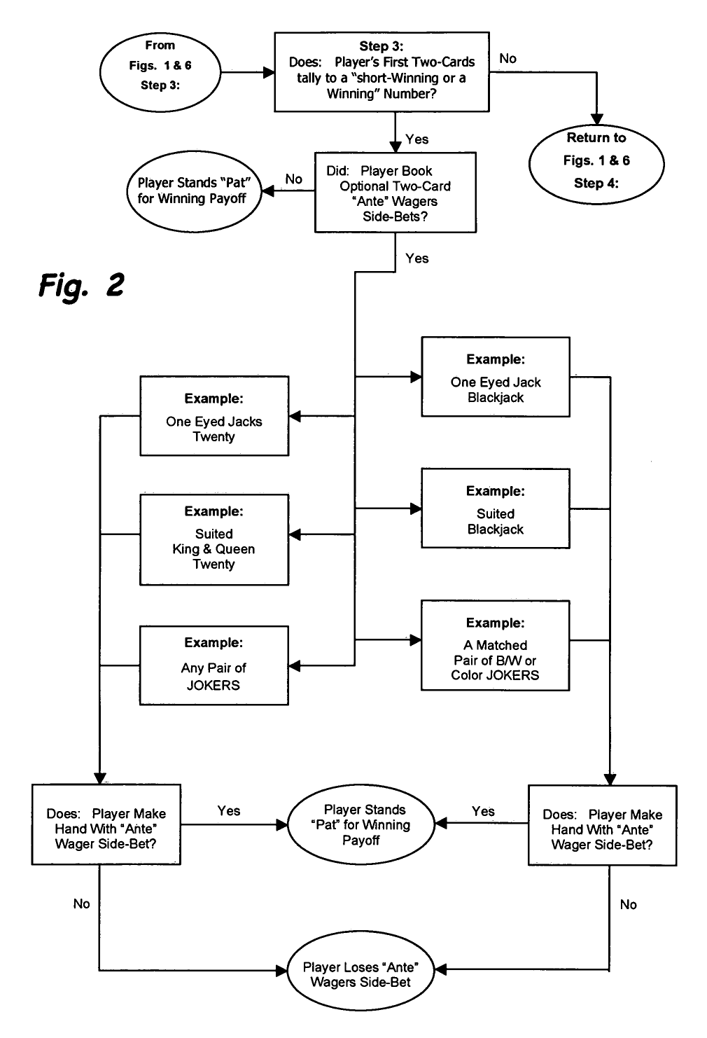

Therefore upon the booking of a required minimum contract wager and optional “Ante” wager Side-bets being offered, a new hand begins with the acquisition of the player's first Two (2) cards. Next, each player assesses their first Two-cards to discover if a first Two-card winning hand tally exists, including any Two-card winning ancillary “Ante” wager Side-bets having been made as shown from Step 3 of FIG. 2.

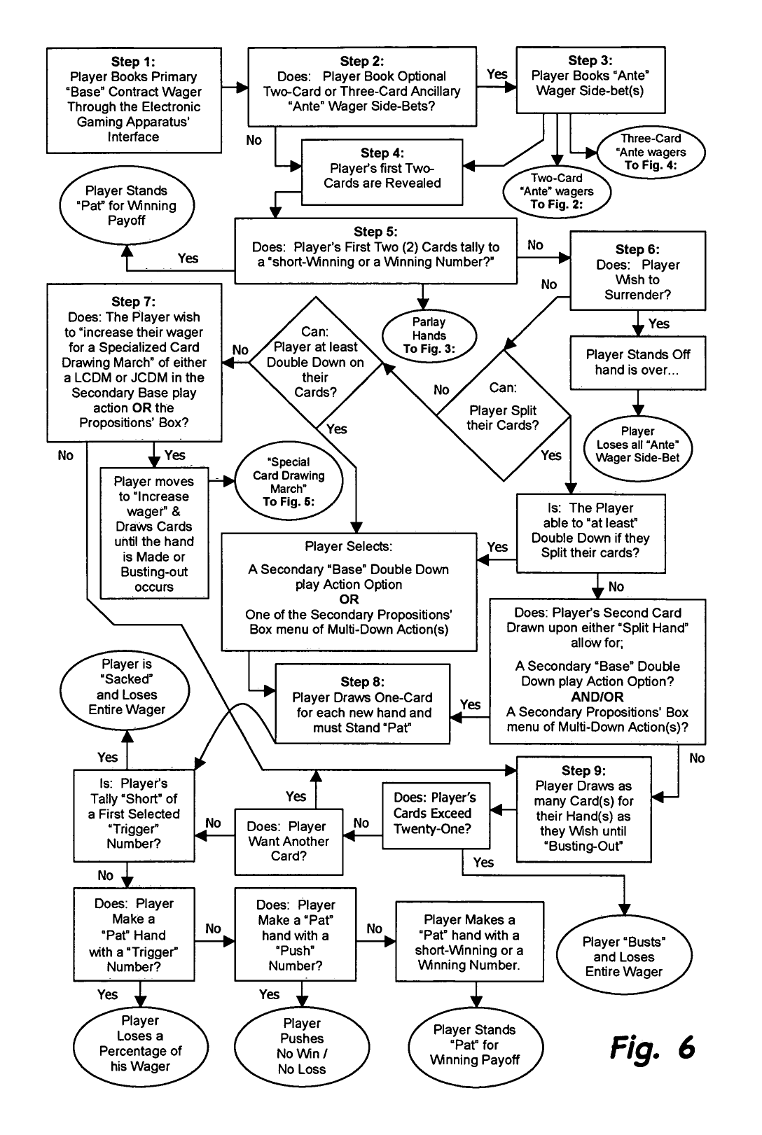

If not, then a decision to Surrender may be considered should that option be available to the player, as illustrated in Step 4 and Step 6 of FIGS. 1 & 6 respectively. In the absence of an immediate winning hand count tally outcome or a desire to Surrender their hand, players will likely be compelled to draw at least One (1) card as to at least avoid being “sacked.” Furthermore, on the one hand, since the player's main motivation is to acquire a hand tally of at least a Winning Number a player might well bypass other play options drawing cards as they see fit without Busting to achieve such ends as illustrated in FIGS. 1, 6 & 7.

Indeed, on the other hand, the general decision to draw card(s) can come with additional possibilities for players to either Split their cards, if the players holds a pair of equally valued cards, Double Down on their cards, assuming their first Two-cards warrant such an action, or both Split and Double Down or even take similar actions for the higher risk/reward “winning” payoffs when booking upon one of the game's Secondary Proposition Multi-Down menu of options.

As such, one of the Parlay hand options or even taking a periodic shot at one of the specialized “CDM's” unfolding from the shoe to include the Joker's Jackpot component, with the proper Ante-up wager being applied is all at work prompting players, as so detailed and illustrated in FIGS. 1, 3, 5, 5a & 6.

FIGS. 1, 3, 5, 5a, 6 & 7, clearly show the flow of progressive events illustrating the player's option to draw card(s) as they see fit without Busting, as well as the player's incumbent need to “Stand Pat” if the player draws the One (1), and typically only One (1), card allowed for either an initial Secondary Base Double Down and/or Secondary Prop-Box's Mufti-Down actions.

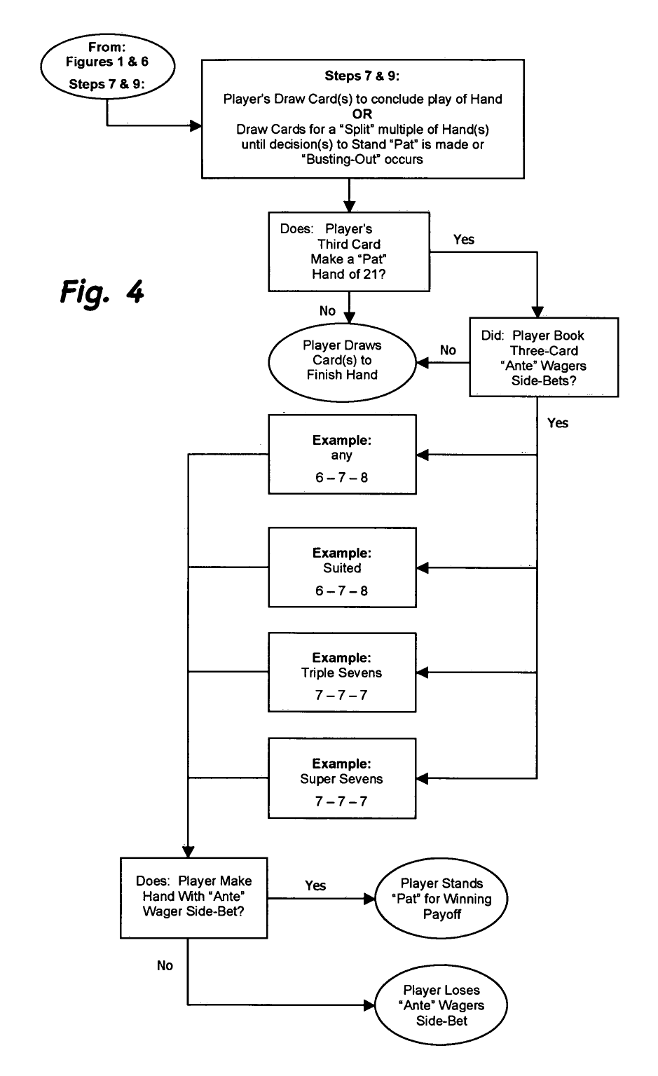

Additionally, since a winning hand count tally often shows upon the draw of a Third card, play action can also be inclusive of a Three-card ancillary Ante wager Side-bet if initially booked, as illustrated in Step 7 of FIG. 4, respectively.

Consequently, FIGS. 1 & 6 also illustrate the consequences of not acquiring a winning hand. As clearly affirmed, if a player Stands Pat with a hand count tally “short” of a first TN or PN being applied to any play action that is of either a Primary or Secondary Base play action variety or, as applied upon any type of Secondary Decisions' play action process; including all forms of Split-hand Parlay plays and/or CDM's, then players are “Sacked,” and lose their entire contract wager as well as any ancillary Ante wager Side-bets for the hand they may have booked.

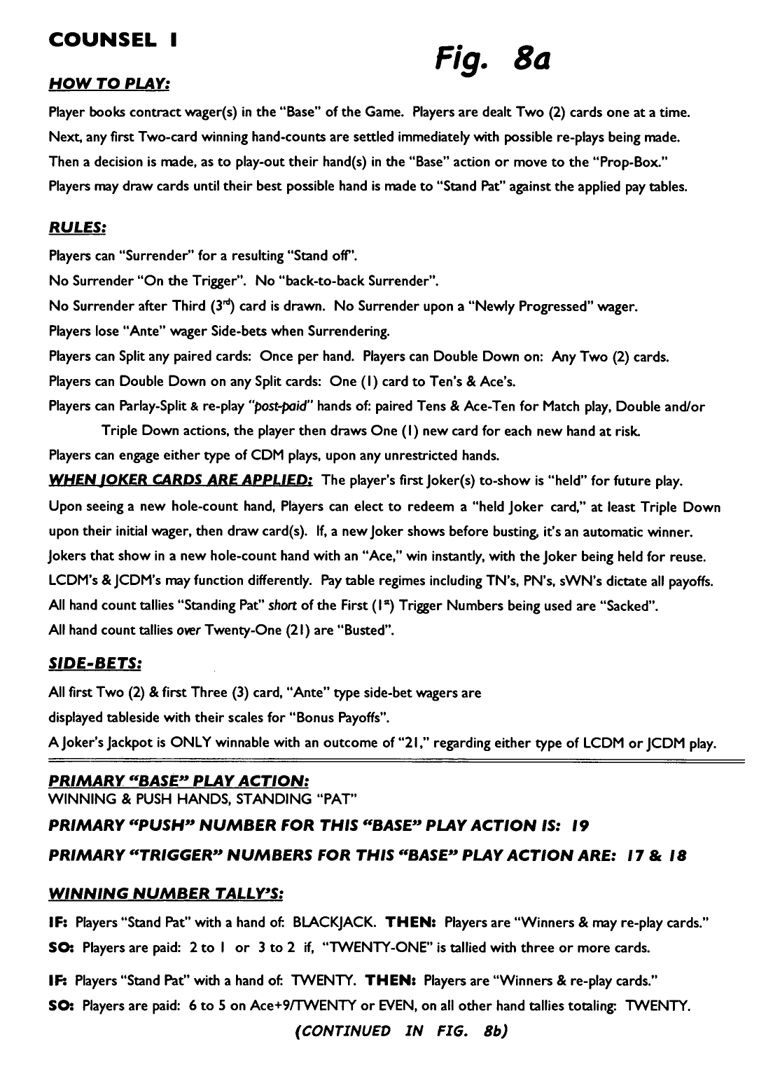

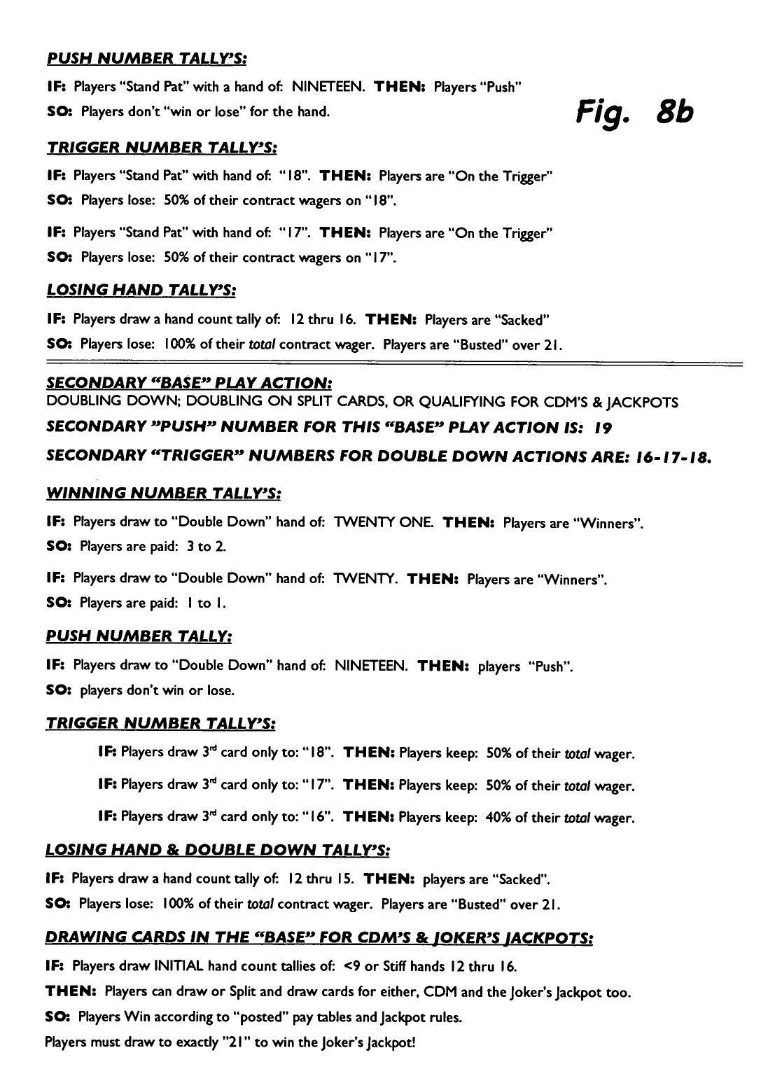

Or, if a player “Stands Pat” upon a hand count tally of a Trigger Number being applied, such players will lose a “hefty percentage portion” of their contract wagers at risk. And, if players Stand Pat on a hand count tally of an optional Push Number being applied, such circumstance resolves the player's hand count tally as a “Push,” again meaning a “no win no lose” outcome for the hand, thereby leaving all short-Winning Number or Winning Number outcomes to be awarded according to their predetermined payoffs, notwithstanding the incumbent need to acquire a final hand-count of “21” to win; a full Card Drawing March payoff, along with any applicable jackpots while Busting-out as a total loss, all hand count tallies “over 21.” Finally, FIGS. 8a through 10c respectively, provide “Exemplary Counsel Embodiments” that unequivocally guide the Applicants' intentions for general play action of their No Dealer Hand “21” methodology.

### Operational Advantages

Suffice it to say, there has never been the ability to establish such a generous menu of wagers with their payoff schedules within the core mathematical boundaries of traditional Blackjack. Neither have the Applicants' ever personally seen, heard of, or read about the idea of, or even the mere suggestion of applying a commissionable percentage fee Vigorish to be cast upon any kind of wager being booked at a traditional Blackjack table, period.

Not to mention such a payoff schedule also being promulgated by way of the very core margin from a new mathematical formulation for “21” play action which classic Dealer-Hand Blackjack methodologies could never have envisioned, accommodated or sustained!

Clearly as the Applicants first discovered and then pursued their notions of using the “lousy Pat hands” of at first; Seventeen (17), Eighteen (18) and Nineteen (19) as “strategic replacements” for the sledge hammer effect of the dealer hand in play action, they too were surprised to see just how formidable the impact upon the integrated core mathematics was going to be, as well as what was to come from their rather “obscure formulation” of this Trigger Number Solution in play.

Certainly, as thoroughly revealed, the Applicants' methodologies and modifications, unlike all others coming before it, provides a significant 50% increase in payoff for a WN outcome of Twenty-One. That is, both outcomes of either a Two-card “Natural” Twenty-One (21) or a multi-card! Twenty-One (21) respectively, while optional Push Numbers represent a zero sum loss to the players and Standing Pat upon applicable Trigger Numbers, “never results in the total loss” of a player's contract wager having been made. And all this, is what operates from just the Primary Base play actions, and not to forget, the new introduction of short-Winning number's to boot!

Regarding the electronic modifications for play, additional advantages of the Applicants' process for playing No Dealer Hand “21” will become operational through the encompassing means of an ever modernizing interactive video gaming apparatuses, as provided for the game.

In considering the Applicants' modifications as applied to an electronic process for play, a “broader scale” of TNs, PNs, sWNs, WNs and the tactical use of Joker cards can be utilized due to the fact that regulatory law and the core mathematics of the Applicants' methodologies function within an environment of broader mathematical opportunity, and the fact that in mobile wireless or video mode the Applicants' gaming process is engaged into a “real time computing environment” wherein the issuance of monetary units (i.e. credits in this case), and therefore their valuations are not so constricting upon the play-by-play action of the Applicants' process for play.

Meaning there are no human factors slowing the game to figure out what can now be a more “sensitive fractional, even ‘mill-age,’ addition or deduction” to a player's wager or payoff, when a decision to Stand Pat on the Trigger from Twelve (12) to Twenty (20) for example, is made and no human mistakes in calculating them are possible either!

Therefore, a perfectly worthwhile process for engaging the Applicants' gaming modifications to the public will be provided through the means of a “multiplayer community based and/or singularly intimate” electronic video display apparatus, wireless telecommunications device or the like.

In so doing, the aforementioned broader scale of Trigger Numbers, and/or Push Numbers,

Winning & short-Winning Numbers could span a plurality of numbers comprising Twelve (12) up to Twenty-One (21) in a most sensitively balanced manner.

As such, the Trigger Number affect upon the player within the bounds of an electronic version of the Applicants' gaming methodology could encompass for example, a player loss of 100% on all hands under Twelve (12), and 100% loss on the actual 12; 100% on 13; 90% on 14; 80% on 15; 75% on 16 for all wagers at risk. Likewise, players could “Push” on 17 & 18, while catching 50% of their wager on a “short-Win” of 19; 120% on certain 2/card 20's; 200% on Blackjack/21, and 150% on certain 3/card 21's for their wagers at risk, or any such kind of plurality mixture of numbers and percentages being applied.

In overview, we have a mathematical thread comprising a rather unique example and uses for Primary Trigger Numbers: 12, 13, 14, 15 & 16. The Push Numbers of 17 & 18, along with the uses of short-Win & Winning Numbers of 19, 20 & 21 or again, any plurality mix of numbers and percentages thereof, that can even fluctuate “on the fly” for manipulative play!

Similarly, there can be an entire Secondary selection of TNs, PNs, sWNs, WNs, and Joker card applications, working across any of the Secondary Decisions' class/menu of wagers, be they either, Base Double Down play actions, Secondary Propositions' Box of Multi-Down play actions or again, any type of CDM being applied as well.

Another “value added” aspect of the video application process is the ability to string any number of video units and/or wireless hand held devices together across any geographical locality supporting any number of ancillary “Ante” wager type Side-bets, specialized “Ante-up” Jackpot Side-bets and/or batteries of progressive “Jackpot” opportunities, not to mention all the tournament play possibilities . . . No Dealer Hand “21” makes for great spectator entertainment!

Most notably, the Applicants' TN, PN, sWN, WN and the Joker-to-show process of play, provides for a key unexpected benefit for both players and casinos alike, wherefore a credible balance between the casino's necessary House Vig-advantage and a player's exposure to it, is definitely made a palatable one. This is directly due to the ameliorating manipulations of the entirety of the Applicants' Primary and/or Secondary Base & Proposition Trigger Number selections and/or group/sets, Primary and/or Secondary Base & Proposition Push Number selections and/or group/sets, as well as the short-Winning & Winning Number selections and/or group/sets as has been thoroughly described and illustrated above, therein producing a ready potential for much improved payoff ratios from this newly integrated core thread. As for the gaming industry, casinos can once again offer their patrons an exciting “companion” option to traditional Blackjack that is quite capable of taking on the market dominance of video Poker, that is simple to grasp, fast to play, and will prove to be even more generous to their patron's Time-In-Play.

Likewise, the Applicants' process of play either in its table gaming format or its interactive electronic format, provides a solution that not only supports richer incentives for a patron's play action, but indeed, the Applicants' methodology will very likely simultaneously propagate a significantly “fatter” Win % value for Housemasters as well by drawing out much larger sums of capital across its play action environment(s) in even shorter spans of time.

Another significant result of the Applicants' process for No Dealer Hand “21” works to restrain the affect of card counting by “directly frustrating” the practical functionality and application of known card counting techniques and strategies due to the direct extraction of the dealer hand “affect” upon the game. And, this is further complemented by the speedy characteristics of the Applicants' game's play action game pace!

Also, benefiting Housemasters' when moving forward with the Applicants' gaming process is the quality and therefore value, weight & impact of the organized “group think” presently being propagated by the “Basic Strategy & Advantage Player classes” upon the traditional Blackjack franchise that is now largely frustrated, yet not entirely, reduced to guessing . . .

To appreciate this is to know that the player's relationship to the cards is now truly “more than less a ‘static’ one,” to the Six (6), Eight (8) or whatever number of deck shoe being used, and not to the dealer's hand “affect” directly. An affect, that represents the most salient purpose for and focus upon essentially every effective card counting system known.

Moreover, from the player's continuum perspective, the Applicants featured solutions advocating a “No Dealer Hand” play action approach to the game, at long last, satiates the single greatest long suffering problem engulfing the typical player play of classic Blackjack. That long suffering problem being, the players' perceived chances of surviving the continuum's unending onslaught of “detestably hot” Blackjack dealer hands!

Because now, there isn't one . . .

We claim:

1. A method for establishing a no dealer hand twenty-one style gaming process engaging any of a number of acceptably configured decks of physical playing cards applying either over Fifty-two cards, Fifty-two cards or under Fifty-two cards, in application to a wholly new play action concept, resulting in the provision of a more mathematically malleable core margin variance, directly benefiting housemasters and players thereof, comprising:
said gaming process utilizing at least one acceptably configured deck of playing cards for uses in a no dealer hand process of twenty-one style play action;
said gaming process having each player placing an initial base contract wager to play the game;
having said each player receive an initial physical two-cards to establish an initial first two-card hand count tally of up to twenty-one for play action;
awarding all first two-card winning hand count tallies according to predetermined payoffs;
having said each player assess their said initial first two-card hand count tallies for a decision to stand pat, or to draw additional cards to pursue play action;
said gaming process having said no dealer hand and using a trigger number means as a replacement for a dealer's hand amidst play action, wherein said trigger number means substantially comprises any numbers from twelve up to twenty;
awarding all hand count tallies of three or more cards according to predetermined payoffs responsive to said player standing upon any applied trigger number, push number or winning number being used;
settling all sacked hand count tallies, short of a first applied trigger number being used, as wins for the house;
settling all said hand count tallies busting over twenty-one as wins for the house.

2. An electronically mechanized gaming method for playing a modified game of twenty-one having no dealer hand in play action while such modified game process is encompassed within an electronic gaming apparatus utilizing an electronic simulation of a number of acceptably configured decks of playing cards, applying either over fifty-two cards, fifty-two cards or under Fifty-two cards for play of the same, all of which results in the provision of a primary play action that gives further rise to a secondary decisions means and play action, through which a new and expanded core margin solution is established for the game directly supporting numerous play actions that significantly increase payoffs to players as well as extend the time-in-play for players, comprising:
said modified game process functioning, via the gaming apparatus, to display the electronic simulation of acceptably configured decks of playing cards that provides a community based or singularly intimate electronic gaming process to play the modified game of no dealer hand twenty-one;
with, said electronic gaming process utilizing said electronic simulation of said acceptably configured decks of playing cards, via said gaming apparatus, to display a first two-cards of an initial two-card hand count tally of up to twenty-one;
also, said electronic gaming process operating, via said gaming apparatus, to display said first two-cards of said initial two-card hand count tally of up to twenty-one and to award all first two-card winning hand count tallies being revealed according to predetermined payoffs;
said electronic gaming process allowing players to draw additional cards to pursue further play actions of the game;
with, said electronic gaming process having a trigger number means being used, via said game apparatus, from twelve up to twenty to replace the absent dealer's hand during play action;
and, said electronic gaming process allowing players to draw at least one additional card for making a hand count tally that avoids being sacked by said hand count tally of less than a first primary trigger number selection being applied, in play action;
also, said electronic gaming process having an optional push number means being used, via said game apparatus, from twelve up to twenty to replace said absent dealer's hand during play action;
with, said electronic gaming process allowing said players to draw at least one additional card for making said hand count tally that avoids being pushed by said hand count tally of an optional first push number selection being applied, in play action;
also, said electronic gaming process operating, via said electronic gaming apparatus, to award all winning hand tallies of three or more cards being revealed according to predetermined payoffs;
with, said electronic gaming process, settling all sacked hand count tallies, short of said first primary trigger number selection being applied, as wins for the house;
and, said electronic gaming process settling all busting hand count tallies over twenty-one as wins for the house.

3. The method of claim 2, further includes said electronic gaming process, utilizing gaming solutions, being provided through the application of a multiplayer community based or singularly intimate solution as applied through an electronic video display apparatuses, wireless telecommunications or wireless mobile Internet devices.

4. The method of claim 2, further includes said electronic gaming process, as utilizing a secondary trigger number means being used, from twelve up to twenty that provides for the direct manipulations of a secondary decisions fork process.

5. The method of claim 4, further includes said electronic gaming process, as utilizing a secondary decisions fork means being used, from twelve up to twenty for the application of trigger numbers, push numbers, short-winning numbers and winning numbers through a multitude of play action wagers and options.

6. The method of claim 4, further includes said electronic gaming process, as utilizing a secondary decisions fork means being used, from twelve up to twenty-one for the application of trigger numbers, push numbers, short-winning numbers and winning numbers through a multitude of parlay re-play hands, card drawing marches and their associated jackpot opportunities.

7. A method for playing twenty-one, engaging the use of at least one type of acceptably configured deck of physical playing cards, of more than fifty-two cards, fifty-two cards or less than fifty-two cards resulting in the provision of a more mathematically malleable core margin variance being distributed during the play action of the game, comprising the steps of:
(a) dealing play action for a twenty-one style game having no dealer's hand in play;
(b) allowing players to make an initial primary base contract wager for play action;
(c) allowing said players to make additional ancillary ante wager side-bets for play action;
(d) dealing all players a physical two-cards for an initial two-card hand count tally of up to twenty-one;
(e) settling all first two-card winning hand count tallies according to predetermined payoffs;
(f) allowing said all players an option to stand pat, or draw at least one additional physical playing card until busting, for pursuing all forms of play actions;
(g) allowing said players to split at least said initial two-card hand count tally, before taking additional physical playing cards, to play out the hands of such said primary base contract wagers for play action;
(h) allowing said players to at least double down on said initial two-card hand count tally, before taking at least a third-card, for playing out their hand upon a selection of secondary decision choices for multi-down play action;
(i) having said players without said first two-card winning hand count tallies to draw at least one additional physical playing card to avoid being sacked for a complete loss with a hand count tally, of less than a first trigger number means being used, from at least a first primary level trigger number being applied, for play action of the game;
(j) having said players standing pat upon said hand count tally, of at least said first trigger number means being used, from at least said first primary level trigger numbers being applied, to at least a primary base action of play, lose a hefty portion of said primary base contract wager for the hand;
(k) having said players without a said first two-card winning hand count tallies, to draw said at least one additional card, to avoid standing pat with a first push number means being used, from at least a first primary level push number being applied, for play action of the game;
(l) having said players standing pat upon said hand count tally, of at least a said first trigger number means being used, from a secondary level of trigger numbers being applied, in completion of any secondary decisions action, lose a hefty portion of their secondary decision's contract wager for the hand;
(m) settling all winning primary hand count tallies of three or more cards according to predetermined payoffs;
(n) settling all sacked hands short of a said first trigger number being used, as a complete loss of a player's wagers;
(o) settling all winning secondary decisions hand tallies of three or more cards according to predetermined payoffs;
(p) settling all busted hands over twenty-one, as a complete loss of a player's wagers.

8. The method of claim 7, further includes said additional ancillary ante wager side-bets, of step (c) as being, both a first two-card or a first three-card outcomes for a hand.

9. The method of claim 7, further includes said players to split at least their said initial two-card hand tally, of step (g) as also applying to any secondary decisions, split hands or split multi-down hands and wagers being booked for play action.

10. The method of claim 7, further includes said players to split at least their said initial two-card hand tally, of step (g) as also applying to any secondary decisions, parlay-split hands or parlay-split multi-down hands and wagers being booked for play action.

11. The method of claim 7, further includes said players to split at least their said initial two-card hand tally, of step (g) as also applying to any secondary decisions for lo hand count, card drawing marches being booked in play action of the game.

12. The method of claim 7, further includes said players to play or split to play, at least their said initial two-card hand tally, of step (g) as also applying to any secondary decisions for joker-card, card drawing marches being booked in play action of the game.

13. The method of claim 7, further includes said at least double down on their said initial two-card hand count tally, of step (h) to substantially comprise, any two or more cards being applied for such play actions.

14. The method of claim 7, further includes said first trigger number means being used, for play action of step (i) to substantially comprise, a plurality of numbers ranging from twelve to twenty.

15. The method of claim 7, further includes said at least first primary level of trigger numbers being applied, for play action of step (i) to substantially comprise, an additional level of secondary trigger numbers to be applied in play action.

16. The method of claim 7, further includes the loss of said hefty portion of their said primary base contract wager, of step (j) to substantially comprise, any amount short of a total loss of the player's said primary base contract wager.

17. The method of claim 7, further includes said at least first primary level of push numbers being applied, for play action of step (k) as all being, optional.

18. The method of claim 7, further includes said at least first push number being used, for play action of step (k) to substantially comprise, a plurality of numbers ranging from twelve to twenty.

19. The method of claim 7, further includes the loss of said hefty portion of their secondary decision's contract wager, of step (1) to substantially comprise, any amount short of a total loss of the players secondary decision's contract wager.
